(19) United States
(12) Patent Application Publication
(10) Pub. No.: US 2013/0032529 A1
(43) Pub. Date: Feb. 7, 2013

(54) RARE EARTH-CONTAINING FILTER BLOCK AND METHOD FOR MAKING AND USING THE SAME

(71) Applicant: Carl Hassler, Gig Harbor, WA (US)

(72) Inventor: Carl Hassler, Gig Harbor, WA (US)

(73) Assignee: MOLYCORP MINERALS, LLC, Greenwood Village, CO (US)

(21) Appl. No.: 13/413,428

(22) Filed: Mar. 6, 2012

Related U.S. Application Data
(63) Continuation of application No. 13/368,310, filed on Feb. 7, 2012, now abandoned.
(60) Provisional application No. 61/440,322, filed on Feb. 7, 2011.
(60) Provisional application No. 61/441,104, filed on Feb. 9, 2011.

(51) Int. Cl. B01D 39/20; B27N 1/02

(52) U.S. Cl. 210/497.01; 210/502.1; 264/109

(57) ABSTRACT

This disclosure relates to a rare earth-containing filter block, more particularly to a rare earth-containing filter block and methods for making and using the rare earth-containing filter block.

### CROSS REFERENCE TO RELATED APPLICATIONS

The present application claims the benefits of U.S. Provisional Application Ser. Nos. 61/440,322 with a filing date of Feb. 7, 2011, and 61/441,104 with a filing date of February 9, both entitled “Method for Making a Rare Earth-Containing Filter and Use Thereof” and each incorporated in its entirety herein by this reference.

Cross reference is made to U.S. patent application Ser. No. 13/205,543 filed Aug. 8, 2011, entitled “AGGLOMERATION OF HIGH SURFACE AREA RARE EARTHS” having attorney docket no. 6062-86, which is incorporated herein by this reference in its entirety.

Cross reference is made to U.S. patent application Ser. No. 13/086,247 filed Apr. 13, 2011, entitled “METHODS AND DEVICES FOR ENHANCING CONTAMINANT REMOVAL BY RARE EARTHS” having attorney docket no. 6062-74, which is incorporated herein by this reference in its entirety.

### FIELD OF INVENTION

This specification relates to a rare earth-containing filter block, and more particularly to a rare earth-containing filter block and methods for making and using the same.

### BACKGROUND OF THE INVENTION

The use of water treatment systems to treat contaminated waters continues to grow dramatically, in part because of and increased contamination of waters, limited pristine water sources, and heightened public awareness of the health concerns associated with the consumption of untreated tap water.

Commonly, water treatment systems vary by the application. Typically, industrial and household water treatment systems differ. Filter blocks are commonly use in both industrial and household water treatment systems. Commonly, the filtration filter block is in the form a hollow, cylindrical or “tubular” filter block. The fluid-flow path through these hollow, cylindrical activated carbon blocks is generally radial, with the water flowing radially through the inner, cylindrical wall to the hollow axial space at the center axis of the block. From the hollow axial space or perforated tube therein, the filtered water flows out of the filter at either at the bottom end or the top end of the filter, depending upon how the internals and ports have been designed.

Filter blocks for water filtration commonly comprises granular activated carbon (GAC) and a binder. The filter block may or may not include additives, such as a lead sorbent and/or an antimicrobial agent. However, granular activated carbon has limited contaminate removal capacity. Therefore, a need exists for a granular media with a broader, higher capacity for removing contaminates from water.

### SUMMARY OF INVENTION

These and other needs are addressed by the various embodiments and configurations presented herein, and moreover the addressing of these needs and other advantages will be apparent from the disclosure contained herein.

Some embodiments include a filter block having agglomerated rare earth particles and activated carbon particles are substantially homogeneously intermixed and cohesively bonded together by a binder, the agglomerated rare earth particles have a plurality of rare earth particles. Preferably, the agglomerated rare earth particles further comprise a polymeric binder. In some formulations of the filter block, the binder and the polymeric binder differ and wherein at least most of the rare earth particles are in contact with the polymeric binder; while in other formulations, the binder and the polymeric binder are the same. Preferably, the binder is one of a thermoset or thermoplastic polymer. The rare earth particles may have an average and/or mean particle size from about 1 nm to about 100 nm. The activated carbon particles may have an average and/or mean particle size from about 40 μm to about 300 μm. In some configurations, the rare earth particles may have a surface area of at more than about 5 m²/g and/or an average and/or mean pore volume of at least about 0.02 cm³/g. In some configurations, the agglomerated rare earth particles may have an average and/or mean particle size from about 1 μm to about 1,000 μm. The rare earth particles may be one of cerium oxide, lanthanum oxide, cerium (IV) oxide, cerium (III) oxide, lanthanum (III) oxide, lanthanum carbonate, cerium carbonate, or a mixture thereof. Preferably, the rare earth particles comprise a rare earth carbonate. The filter block may have a shape generally resembling one of a sheet, a film, solid cylinder, or tubular cylinder.

Some embodiments include a method for making a filter block by forming a slurry mixture comprising activated carbon particles, rare earth particles, and a binder; charging the mixture to a mold; applying thermal energy to the mixture to cohesively bind together the activated carbon particles and the rare earth particles to form a filter block; and removing the filter block from the mold. Preferably, the slurry mixture is an aqueous slurry mixture. Preferably, the applying thermal energy step raises the temperature of the mixture to one or both of the melt temperature and tackifying temperature of binder. In some configurations, the method may further include, applying pressure to the mixture one or more of before, during, and after the applying of thermal energy to the mixture. Some configurations of the method may further include, venting of mold during one or more of before, during, and after the applying of thermal energy to the mixture. Preferably, the method further includes venting at least some water vapor during at least some of the applying thermal energy step, preferably venting at least some water vapor during at least most of the applying thermal energy step. In some configurations, the method may further include, cooling the mold before the removing the filter block from the mold. Preferably, the binder is one of a thermoset and thermoplastic polymer, more preferably the binder is one of an acrylic polymer, an acrylic co-polymer, a polyethylene polymer, a polyethylene co-polymer, or a combination thereof. In some embodiments, the rare earth particles are in the form of agglomerated rare earth particles. The rare earth particles can be one of cerium oxide, lanthanum oxide, cerium (IV) oxide, cerium (III) oxide, lanthanum (III) oxide, lanthanum carbonate, cerium carbonate, or a mixture thereof. Preferably, the rare earth particles are a rare earth carbonate. The rare earth particles may have an average and/or mean particle size from about 1 nm to about 100 nm. The activated carbon particles may have an average and/or mean particle size from about 4 μm to about 300 μm. In some configurations, the rare earth particles may have a surface area of at more than about 5 m²/g and/or an average and/or mean pore volume of at least about 0.02 cm³/g. In some configurations, the agglomerated rare earth particles may have an average and/or mean particle size from about 1 μm to about 1,000 μm. The filter block may have a shape generally resembling one of a sheet, a film, solid cylinder, or tubular cylinder.

Some embodiments include a method for making a filter block by forming a mixture comprising activated carbon particles, rare earth particles, and a binder; charging the mixture to a mold; applying thermal energy to the mixture to cohesively bind together the activated carbon particles and the rare earth particles to form a filter block; venting the at least some water vapor during the applying thermal energy step; and removing the filter block from the mold. Preferably, the applying thermal energy step raises the temperature of the mixture to one or both of the melt temperature and tackifying temperature of binder. In some embodiments, the method further includes, applying pressure to the mixture one or more of before, during, and after the applying of thermal energy to the mixture. Preferably, the method includes cooling the mold before the removing the filter block from the mold. Preferably, the binder is one of a thermoset or thermoplastic polymer. The rare earth particles may have an average and/or mean particle size from about 1 nm to about 100 nm. The activated carbon particles may have an average and/or mean particle size from about 40 μm to about 300 μm. In some configurations, the rare earth particles may have a surface area of at more than about 5 m²/g and/or an average and/or mean pore volume of at least about 0.02 cm³/g. In some configurations, the agglomerated rare earth particles may have an average and/or mean particle size from about 1 μm to about 1,000 μm. The rare earth particles may be one of cerium oxide, lanthanum oxide, cerium (IV) oxide, cerium (III) oxide, lanthanum (III) oxide, lanthanum carbonate, cerium carbonate, or a mixture thereof. Preferably, the rare earth particles comprise a rare earth carbonate. The filter block may have a shape generally resembling one of a sheet, a film, solid cylinder, or tubular cylinder.

Some embodiments include a contaminant-containing filter block having agglomerated rare earth particles having at least a first contaminant sorbed by at least some of the rare earth particles and activated carbon particles having at least a second contaminant sorbed by at least some of the activated carbon particles. The agglomerated rare earth particles and the activated carbon particles are substantially homogeneously intermixed and cohesively bonded together by a binder, the agglomerated rare earth particles have a plurality of rare earth particles. In some embodiments, the first and second contaminants differ. In some embodiments, the first and second contaminants are the same. The first and second contaminant can be one or more of arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, or a chemical contaminant. Preferably, the agglomerated rare earth particles further comprise a polymeric binder. In some formulations of the filter block, the binder and the polymeric binder differ and wherein at least most of the rare earth particles are in contact with the polymeric binder; while in other formulations, the binder and the polymeric binder are the same. Preferably, the binder is one of a thermoset or thermoplastic polymer. The rare earth particles may have an average and/or mean particle size from about 1 nm to about 100 nm. The activated carbon particles may have an average and/or mean particle size from about 40 μm to about 300 μm. In some configurations, the rare earth particles may have a surface area of at more than about 5 m²/g and/or an average and/or mean pore volume of at least about 0.02 cm³/g. In some configurations, the agglomerated rare earth particles may have an average and/or mean particle size from about 1 μm to about 1,000 μm. The rare earth particles may be one of cerium oxide, lanthanum oxide, cerium (IV) oxide, cerium (III) oxide, lanthanum (III) oxide, lanthanum carbonate, cerium carbonate, or a mixture thereof. Preferably, the rare earth particles comprise a rare earth carbonate. The filter block may have a shape generally resembling one of a sheet, a film, solid cylinder, or tubular cylinder.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “activated carbon,” as used herein, refers to highly porous carbon having a random structure, amorphous structure, or a combination thereof. Furthermore, the activated carbon may have additional and/or alternative properties as may be presented or implied from the discussion below. The term activated carbon includes, but is not limited to, carbon derived from bituminous or other forms of coal, pitch, bones, nut shells, coconut shells, corn husks, polyacrylonitrile (PAN) polymers, charred cellulosic fibers or materials, wood, and the like. Activated carbon from any source can be used, such as that derived from bituminous coal or other forms of coal, or from pitch, bones, nut shells, coconut shells, corn husks, polyacrylonitrile (PAN) polymers, charred cellulosic fibers or materials, wood, and the like. Activated carbon particles can, for example, be formed directly by activation of coal or other materials, or by grinding carbonaceous material to a fine powder.

“Absorption” refers to the penetration of one substance into the inner structure of another substance, as distinguished from adsorption.

“Adsorption” refers to the adherence of atoms, ions, molecules, polyatomic ions, or other substances to the surface of another substance, called the adsorbent. Typically, the attractive force for adsorption can be in the form of a bond and/or force, such as covalent bonds, metallic bonds, coordination bonds, ionic bonds, hydrogen bonds, electrostatic forces (e.g., van der Waals and/or London's forces), and the like.

The terms “agglomerate” and “aggregate” refer to a composition formed by gathering one or more materials into a mass.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

A “binder” generally refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime, lignosulphonate oils, hydrocarbons, glycerin, stearate, or combinations thereof. The binder may or may not chemically react with the material being agglomerated. Non-liming examples of chemical reactions include hydration/dehydration, metal ion reactions, precipitation/gelation reactions, and surface charge modification.

As used herein, “one or more of” and “at least one of” when used to preface several elements or classes of elements such as X, Y and Z or X₁-Xₙ, Y₁-Y₁ and Z₁-Zₙ, is intended to refer to a single element selected from X or Y or Z, a combination of elements selected from the same class (such as X₁ and X₂), as well as a combination of elements selected from two or more classes (such as Y₁ and Zₙ).

The term “composition” generally refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

“Chemical species” or “species” are atoms, elements, molecules, molecular fragments, ions, compounds, and other chemical structures.

“Chemical transformation” refers to process where at least some of a material has had its chemical composition transformed by a chemical reaction. A “chemical transformation” differs from “a physical transformation”. A physical transformation refers to a process where the chemical composition has not been chemically transformed but a physical property, such as size or shape, has been transformed.

The term “contained within the water” generally refers to materials suspended and/or dissolved within the water. Water is typically a solvent for dissolved materials and water-soluble material. Furthermore, water is typically not a solvent for insoluble materials and water-insoluble materials. Suspended materials are substantially insoluble in water and dissolved materials are substantially soluble in water. The suspended materials have a particle size.

As used herein, “contaminate” refers to any unwanted composition or mixture of compositions contained within the water. Generally, the term contaminant includes one or more of arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, a chemical contaminant, or a mixture thereof.

“De-toxify” or “de-toxification” includes rendering a target material, such as chemical and/or biological target material non-toxic or non-harmful to a living organism, such as, for example, human or other animal. The target material may be rendered non-toxic by converting the target material into a non-toxic or non-harmful form or species.

The term “fluid” refers to a liquid, gas or both.

A “halogen” is a nonmetal element from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen.

A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F⁻), chloride (Cl⁻), bromide (Br⁻), iodide (I⁻) and astatide (At⁻).

The term “inorganic material” generally refers to a chemical compound or other species that is not an organic material.

The term “incorporating,” as used herein, refers to including, such as including a functional element of a device, apparatus or system. Incorporation in a device may be permanent, such as a non-removable filter cartridge in a disposable water filtration device, or temporary, such as a replaceable filter cartridge in a permanent or semi-permanent water filtration device.

The term “insoluble” refers to materials that are intended to be and/or remain as solids in water. Insoluble materials are able to be retained in a device, such as a column, or be readily recovered from a batch reaction using physical means, such as filtration. Insoluble materials should be capable of prolonged exposure to water, over weeks or months, with little loss of mass. Typically, a little loss of mass refers to less than about 5% mass loss of the insoluble material after a prolonged exposure to water.

An “ion” generally refers to an atom or group of atoms having a charge. The charge on the ion may be negative or positive.

The term “low melt index polymeric material,” as used herein, means a polymeric material having a melt index less than 1.0 g/10 min., as determined by ASTM D 1238 at 190° C. and 15 kg load.

The term “oxidizing agent” generally refers to one or both of a chemical substance and physical process that transfers and/or assists in removal of one or more electrons from a substance. The substance having the one or more electrons being removed is oxidized. In regards to the physical process, the physical process may removal and/or may assist in the removal of one or more electrons from the substance being oxidized. For example, the substance to be oxidized can be oxidized by electromagnetic energy when the interaction of the electromagnetic energy with the substance be oxidized is sufficient to substantially remove one or more electrons from the substance. On the other hand, the interaction of the electromagnetic energy with the substance being oxidized may not be sufficient to remove one or more electrons, but may be enough to excite electrons to higher energy state, were the electron in the excited state can be more easily removed by one or more of a chemical substance, thermal energy, or such.

The terms “pore volume” and “pore size”, respectively, refer to pore volume and pore size determinations made by any suite measure method. Preferably, the pore size and pore volume are determined by any suitable Barret-Joyner-Halenda method for determining pore size and volume. Furthermore, it can be appreciated that as used herein pore size and pore diameter can used interchangeably.

“Precipitation” generally refers to the removal of a dissolved target material in the form of an insoluble target material-laden rare earth composition. The target material-laden rare earth composition can comprise a target-laden cerium (IV) composition, a target-laden rare earth-containing additive composition, a target-laden rare composition comprising a rare earth other than cerium (IV), or a combination thereof. Typically, the target material-laden rare earth composition comprises an insoluble target material-laden rare earth composition. For example, “precipitation” includes processes, such as adsorption and absorption of the target material by one or more of the cerium (IV) composition, the rare earth-containing additive, or a rare earth other than cerium (IV). The target-material laden composition can comprise a +3 rare earth, such as cerium (III), lanthanum (III) or other lanthanoid having a +3 oxidation state.

A “radical” generally refers to an atom or group of atoms that are joined together in some particular spatial structure and commonly take part in chemical reactions as a single unit. A radical is more generally an atom, molecule, or ion (as an atom or group of atoms) with one or more unpaired electrons. A radical may have a net positive or negative charge or be neutral.

“Rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The terms “rare earth”, “rare earth-containing composition”, “rare earth-containing additive” and “rare earth-containing particle” refer both to singular and plural forms of the terms. By way of example, the term “rare earth” refers to a single rare earth and/or combination and/or mixture of rare earths and the term “rare earth-containing composition” refers to a single composition comprising a single rare earth and/or a mixture of differing rare earth-containing compositions containing one or more rare earths and/or a single composition containing one or more rare earths. The terms “rare earth-containing additive” and “rare earth-containing particle” are additives or particles including a single composition comprising a single rare earth and/or a mixture of differing rare earth-containing compositions containing one or more rare earths and/or a single composition containing one or more rare earths. The term “processed rare earth composition” refers not only to any composition containing a rare earth other than non-compositionally altered rare earth-containing minerals. In other words, as used herein “processed rare earth-containing composition” excludes comminuted naturally occurring rare earth-containing minerals. However, as used herein “processed rare earth-containing composition” includes a rare earth-containing mineral where one or both of the chemical composition and chemical structure of the rare earth-containing portion of the mineral has been compositionally altered. More specifically, a comminuted naturally occurring bastnasite would not be considered a processed rare earth-containing composition and/or processed rare earth-containing additive. However, a synthetically prepared bastnasite or a rare earth-containing composition prepared by a chemical transformation of naturally occurring bastnasite would be considered a processed rare earth-containing composition and/or processed rare earth-containing additive. The processed rare earth and/or rare-containing composition and/or additive are, in one application, not a naturally occurring mineral but synthetically manufactured. Exemplary naturally occurring rare earth-containing minerals include bastnasite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

The term “reducing agent”, “reductant” or “reducer” generally refers to an element or compound that donates one or more electrons to another species or agent this is reduced. In the reducing process, the reducing agent is oxidized and the other species, which accepts the one or more electrons, is reduced.

The terminology “removal”, “remove” or “removing” includes the sorption, precipitation, conversion, detoxification, deactivation, and/or combination thereof of a target material contained in a water and/or water handling system.

The term “soluble” refers to a material that readily dissolves in a fluid, such as water or other solvent. For purposes of this disclosure, it is anticipated that the dissolution of a soluble material would necessarily occur on a time scale of minutes rather than days. For the material to be considered to be soluble, it is necessary that the material/composition has a significant solubility in the fluid such that upwards of about 5 g of the material will dissolve in about one liter of the fluid and be stable in the fluid.

The term “sorb” refers to adsorption, absorption or both adsorption and absorption.

The term “suspension” refers to a heterogeneous mixture of a solid, typically in the form of particulates dispersed in a liquid. In a suspension, the solid particulates are in the form of a discontinuous phase dispersed in a continuous liquid phase. The term “colloid” refers to a suspension comprising solid particulates that typically do not settle-out from the continuous liquid phase due to gravitational forces. A “colloid” typically refers to a system having finely divided particles ranging from about 10 to 10,000 angstroms in size, dispersed within a continuous medium. As used hereinafter, the terms “suspension”, “colloid” or “slurry” will be used interchangeably to refer to one or more materials dispersed and/or suspended in a continuous liquid phase.

The term “surface area” refers to surface area of a material and/or substance determined by any suitable surface area measurement method. Preferably, the surface area is determined by any suitable Brunauer-Emmett-Teller (BET) analysis technique for determining the specific area of a material and/or substance.

The term “water” generally refers to any aqueous stream. The water may originate from any aqueous stream may be derived from any natural and/or industrial source. Non-limiting examples of such aqueous streams and/or waters are drinking waters, potable waters, recreational waters, waters derived from manufacturing processes, wastewaters, pool waters, spa waters, cooling waters, boiler waters, process waters, municipal waters, sewage waters, agricultural waters, ground waters, power plant waters, remediation waters, co-mingled water and combinations thereof.

The term “water handling system” refers to any system containing, conveying, manipulating, physically transforming, chemically processing, mechanically processing, purifying, generating and/or forming the aqueous composition, treating, mixing and/or co-mingling the aqueous composition with one or more other waters and any combination thereof.

A “water handling system component” refers to one or more unit operations and/or pieces of equipment that process and/or treat water (such as a holding tank, reactor, purifier, treatment vessel or unit, mixing vessel or element, wash circuit, precipitation vessel, separation vessel or unit, settling tank or vessel, reservoir, pump, aerator, cooling tower, heat exchanger, valve, boiler, filtration device, solid liquid and/or gas liquid separator, nozzle, tender, and such), conduits interconnecting the unit operations and/or equipment (such as piping, hoses, channels, aqua-ducts, ditches, and such) and the water conveyed by the conduits. The water handling system components and conduits are in fluid communication.

The terms “water” and “water handling system” will be used interchangeably. That is, the term “water” may used to refer to “a water handling system” and the term “water handling system” may be used to refer to the term “water”.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosed aspects, embodiments, and configurations can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a filter block sheet and/or filter block sheet according to some embodiments;

FIG. 2 depicts a filter block cylinder according to some embodiments;

FIG. 3 depicts a filter block tubular cylinder according to some embodiments;

FIG. 4A depicts fluid flow through a filter block embodiment according to FIG. 2;

FIG. 4B depicts fluid flow through a filter block embodiment according to FIG. 3;

FIG. 5 depicts fluid flow through a filter block embodiment according FIG. 2;

FIG. 6 depicts a process for making agglomerated rare earth particles according some embodiments;

FIG. 7 depicts a rare filter block of FIGS. 1-3 according to some embodiments;

FIG. 8 depicts a rare filter block of FIGS. 1-3 according to some embodiments;

FIG. 9 depicts a rare filter block according to another embodiment;

FIG. 10 depicts a process for making a filter block according to some embodiments;

FIG. 11 depicts arsenic removal capacity for agglomerates according to an embodiment;

FIG. 12 is a bar graph comparing arsenic (III) removal capacity derived from isotherms data at pH values of pH 6.5, pH 7.5 and pH 8.5;

FIG. 13 depicts a schematic of a testing apparatus for agglomerates; and

FIG. 14 depicts contaminate challenge tests for agglomerates prepared according to various embodiments.

### DESCRIPTION OF THE INVENTION

In accordance with some embodiments, the following disclosure relates to a filter block comprising activated carbon and a rare earth. The activated carbon is preferably in the form of activated carbon particles. The rare earth may comprise one or more rare earth-containing compositions, preferably in the form of rare earth particles. The activated carbon particles and rear earth particles are preferably bond together by a binder. The binder is preferably a polymeric binder.

The filter block can one or both of remove and detoxify a fluid stream containing one or more contaminants. The fluid stream is preferably in the form of a gas, liquid or mixture of thereof. Preferably, the fluid stream comprises water.

The rare earth particles and the activated carbon particles are separate and distinct particles. The activated carbon particles and the rare earth particles, respectively, have mean and/or average particle sizes. The activated carbon particles and rare earth particles may have, respectively, substantially about same particle size average and/or mean particles sizes or the average and/or mean particle sizes may differ. In some embodiments, the average and/or mean particle size of the activated carbon and rare earth particles commonly differ by no more than about 1 micron, more commonly the average and/or mean particle size of the activated carbon and rare earth particles differ by no more than about 5 microns, even more commonly the average and/or mean particle size of the activated carbon and rare earth particles differ by no more than about 10 microns, yet even more commonly the average and/or mean particle size of the activated carbon and rare earth particles differ by no more than about 15 microns, still yet even more commonly the average and/or mean particle size of the activated carbon and rare earth particles differ by no more than about 20 microns, still yet even more commonly the average and/or mean particle size of the activated carbon and rare earth particles differ by no more than about 35 microns, still yet even more commonly the average and/or mean particle size of the activated carbon and rare earth particles differ by no more than about 45 microns, still yet even more commonly the average and/or mean particle size of the activated carbon and rare earth particles differ by no more than about 50 microns, still yet even more commonly the average and/or mean particle size of the activated carbon and rare earth particles differ by no more than about 60 microns, still yet even more commonly the average and/or mean particle size of the activated carbon and rare earth particles differ by no more than about 75 microns, still yet even more commonly the average and/or mean particle size of the activated carbon and rare earth particles differ by no more than about 90 microns, still yet even more commonly the average and/or mean particle size of the activated carbon and rare earth particles differ by no more than about 100 microns, still yet even more commonly the average and/or mean particle size of the activated carbon and rare earth particles differ by no more than about 125 microns, still yet even more commonly the average and/or mean particle size of the activated carbon and rare earth particles differ by no more than about 150 microns, still yet even more commonly the average and/or mean particle size of the activated carbon and rare earth particles differ by no more than about 180 microns, still yet even more commonly the average and/or mean particle size of the activated carbon and rare earth particles differ by no more than about 200 microns, still yet even more commonly the average and/or mean particle size of the activated carbon and rare earth particles differ by no more than about 250 microns, still yet even more commonly the average and/or mean particle size of the activated carbon and rare earth particles differ by no more than about 300 microns, still yet even more commonly the average and/or mean particle size of the activated carbon and rare earth particles differ by no more than about 350 microns, still yet even more commonly the average and/or mean particle size of the activated carbon and rare earth particles differ by no more than about 400 microns, still yet even more commonly the average and/or mean particle size of the activated carbon and rare earth particles differ by no more than about 500 microns, or yet still even more commonly the average and/or mean particle size of the activated carbon and rare earth particles differ by no more than about 600 microns.

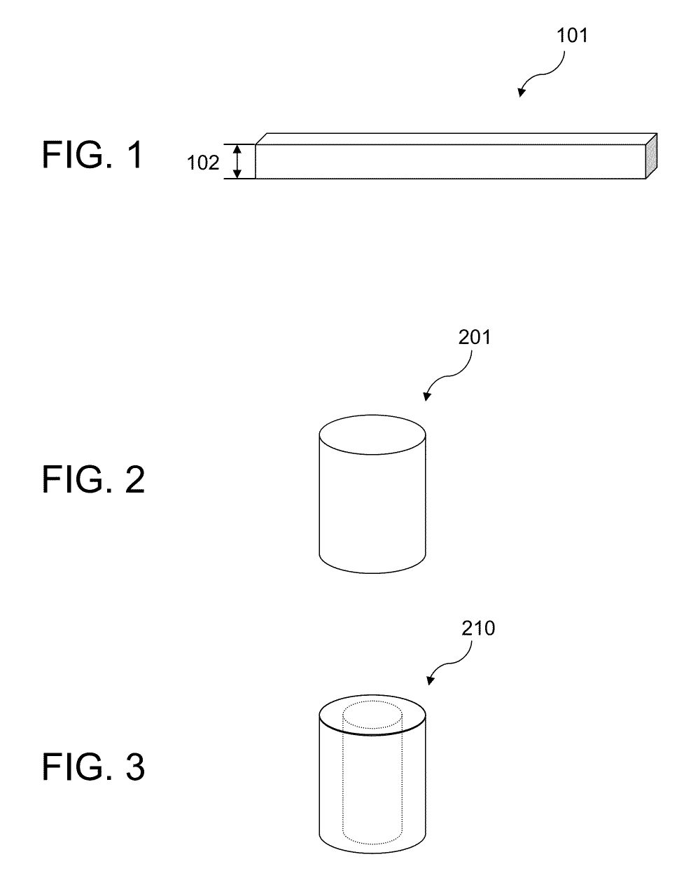

The filter block may have any shape. Suitable non-limiting examples of filter block shapes are depicted in FIGS. 1-3. FIG. 1 depicts a filter block substantially resembling a sheet 101 having a thickness 102. FIG. 2 depicts a filter block substantially resembling a solid cylinder 210. FIG. 3 depicts a filter block substantially resembling a tubular cylinder 210.

Filter blocks in the form of sheet 101 can, in some embodiments, have a thickness 102 of a micron or less. In other embodiments, filter blocks in the form of sheet can have a thickness of a micron or more.

In some embodiments, the filter block has a volume commonly from about 1 and 1,000 cm³, more commonly a volume of from about 10 to about 100 cm³, even more commonly from about 10 and 50 cm³. The volume of the filter block is without regard for macroscopic spaces, such as a hollow core, or for pores between the active media grains and the volume of the filter block taken to refer to a continuous solid filter block without pores or hollow portions.

In some embodiments, the filter block has an external surface area commonly from about 1 to about 2,000 cm², even more commonly from about 10 to about 500 cm², yet even more commonly from about 50 to about 75 cm². External surface area is used here to mean the surface area of a filter block through which incoming water can enter the block.

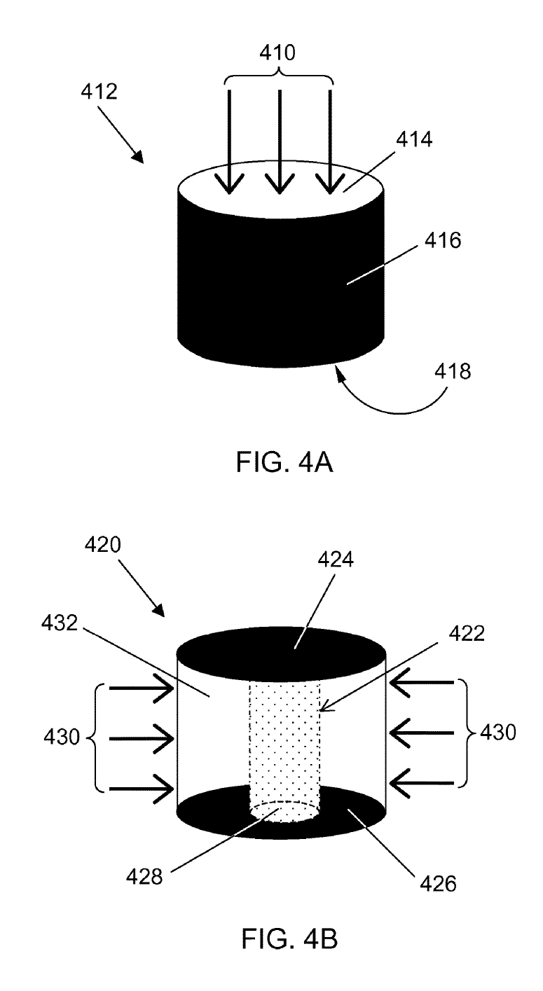

While not wanting to be limited by example, FIG. 4A depicts a filter block according to some embodiments, incoming, untreated water 410 can enter the filter block 412 through a top circular surface 414. Outside cylindrical surface 416 all around the filter block is sealed to prevent water from escaping through the sides. Incoming, untreated water 410 can travel through the filter block 412 from the surface 414 to opposite surface 418 where treated water (not shown) can exit the filter block 412. The external surface area of filter block 412 is the area of the circular surface 414.

While not wanting to be limited by example, FIG. 4B depicts a filter block according to some embodiments. The filter block 420 has a hollow core 422. Surface 424 is sealed to prevent water from entering either the filter block 420 or the hollow core 422. Surface 426 is also sealed. There is an opening 428 in the surface 426, which is an open end of hollow core 422. Incoming, untreated water 430 can enter the filter block 420 all around the circumference of the block 420 through outside cylindrical surface 432. The untreated water 430 can travel through the filter block 420 from the surface 432 to the hollow core 422 where treated water (not shown) can exit the filter block 420 through the opening 428. The external surface area of block 420 is the area of outside cylindrical surface 432.

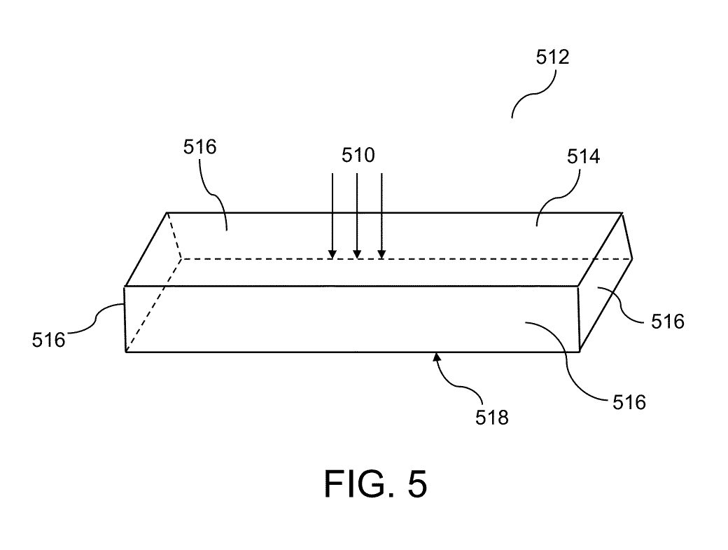

While not wanting to be limited by example, FIG. 5 depicts a filter block according to some embodiments incoming, untreated water 510 can enter the filter block 512 through a top substantially flat surface 514. Outside perimeter surfaces 516 of the filter block are sealed to prevent water from escaping through the sides. Incoming, untreated water 510 can travel through the filter block 512 from the surface 514 to opposing surface 518 where treated water (not shown) can exit the filter block 512.

Rare Earth, Rare Earth-Containing Composition and/or Rare Earth Particles

The rare earth particles may comprise a rare earth, rare earth-containing composition, or both a rare earth and rare earth-containing composition. The rare earth particles may be water-soluble, water-insoluble, a combination of water-soluble and water-insoluble rare earths and rare earth-containing compositions.

Commonly, the earth particles comprise cerium, in the form of a cerium-containing compound and/or an ionic form of cerium, lanthanum, in the form of a lanthanum-containing compound and/or ionic form of lanthanum, or a mixture thereof. More commonly the rare earth particles comprise cerium (IV) oxides, cerium (III) oxides, cerium (IV) compositions (preferably, in the form of ceric salts), cerium (III) compositions (preferably, in the form of cerous salts), lanthanum (III) oxides, lanthanum (III) compositions (preferably, in the form of lanthanum salts), or mixtures and/or combinations thereof.

The rare earth particles may contain one or more rare earths and/or rare earth-containing compositions, and may be in any suitable form. Non-limiting examples of rare earth particles include cerium (III) oxides, cerium (IV) oxides, ceric (IV) salts (such as ceric chloride, ceric bromide, ceric iodide, ceric sulfate, ceric nitrate, ceric chlorate, and ceric oxalate), cerium (III) salts (such as cerous chloride, cerous bromide, cerous iodide, cerous sulfate, cerous nitrate, cerous chlorate, and cerous oxalate), lanthanum (III) oxides, lanthanum (III) salts (such as lanthanum chloride, lanthanum bromide, lanthanum iodide, lanthanum chlorate, lanthanum sulfate, lanthanum oxalate, and lanthanum nitrate), and mixtures thereof. In some embodiments, the rare earth particles may be in the form of a free-flowing powder or other form.

The rare earth rare earth particles can be in elemental, ionic, compounded or combination thereof form. The rare earth particles can be contained in the form of nanoparticles, particles larger than nanoparticles, agglomerates, or aggregates or combinations and/or mixtures thereof. The rare earth particles can comprise one or more rare earths and/or rare earth-containing compositions. The rare earths may be of the same or different valence and/or oxidation states and/or numbers. The rare earths can be a mixture of different rare earths, such as two or more of yttrium, scandium, cerium, lanthanum, praseodymium, and neodymium. In some embodiments, the rare earth particle can be contained in a fluid, such as water.

The rare earth particles may comprise in some embodiments a processed rare earth-containing composition and the rare earth particles do not include, or are substantially free of, a naturally occurring and/or derived mineral. In some embodiments, the rare earth particles are substantially free of one or more elements in Group 1, 2, 4-15, or 17 of the Periodic Table, and are substantially free of hazardous radioactive isotopes, such as uranium, sulfur, selenium, tellurium, and polonium.

In some formulations, the rare earth particles comprise one or more rare earths. While not wanting to be limited by example, the rare earth particles can comprise a first rare earth and a second rare earth. The first and second rare earths may have the same or differing atomic numbers. In some formulations, the first rare earth comprises cerium (IV) and the second rare earth comprises a rare earth other than cerium (IV). The rare earth other than cerium (IV) can be one or more trivalent rare earths, such as cerium (III), or any other trivalent rare other than cerium (III). For example, a mixture of rare earth-containing compositions can comprise a first rare earth having a +4 oxidation state and a second rare earth having a +3 oxidation state. In some embodiments, the first and second rare earths are the same and comprise cerium. More specifically, the first rare earth comprises cerium (IV) and the second rare earth comprises cerium (III). Preferably, the cerium is primarily in the form of a water-insoluble cerium (IV) composition, with the remaining cerium being present as trivalent rare earths. The other trivalent rare earths are preferably substantially insoluble trivalent rare earths. In some formulations, at least some of the trivalent rare earths are water trivalent rare earth-containing compositions.

In one formulation, the cerium is primarily cerium (IV) oxide, with the remaining cerium being present as cerium (III). For rare earth-containing compositions having a mixture of +4 and +3 oxidations states commonly at least some of the rare earth has a +4 oxidation sate, more commonly at least most of the rare earth has a +4 oxidation state, more commonly at least about 75 wt % of the rare earth has a +4 oxidation state, even more commonly at least about 90 wt % of the rare earth has a +4 oxidation state, and yet even more commonly at least about 98 wt % of the rare earth has a +4 oxidation state. The rare earth-containing composition commonly includes at least about 1 ppm, more commonly at least about 10 ppm, and even more commonly at least about 100 ppm cerium (III). While in some embodiments, the rare earth-containing composition includes at least about 0.0001 wt % cerium (III), preferably at least about 0.001 wt % cerium (III) and even more preferably at least about 0.01 wt % cerium (III) calculated as cerium oxide. Moreover, in some embodiments, the rare earth composition-containing commonly has at least about 20,000 ppm cerium (IV) oxide, more commonly at least about 100,000 ppm cerium (IV) and even more commonly at least about 250,000 ppm cerium (IV).

In some formulations, the molar ratio of cerium (IV) to cerium (III) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Moreover, in some formulations the molar ratio of cerium (III) to cerium (IV) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Further, these molar ratios apply for any combinations of soluble and insoluble forms of Ce (IV) and soluble and insoluble forms of Ce (III).

In one formulation, the cerium is primarily cerium (III), with the remaining cerium being present as cerium (IV) oxide. For rare earth-containing compositions having a mixture of +3 and +4 oxidations states commonly at least some of the rare earth has a +3 oxidation sate, more commonly at least most of the rare earth has a +3 oxidation state, more commonly at least about 75 wt % of the rare earth has a +3 oxidation state, even more commonly at least about 90 wt % of the rare earth has a +3 oxidation state, and yet even more commonly at least about 98 wt % of the rare earth has a +3 oxidation state. The rare earth-containing composition commonly includes at least about 1 ppm, more commonly at least about 10 ppm, and even more commonly at least about 100 ppm cerium (IV) oxide. While in some embodiments, the rare earth-containing composition includes at least about 0.0001 wt % cerium (IV), preferably at least about 0.001 wt % cerium (IV) and even more preferably at least about 0.01 wt % cerium (IV) calculated as cerium oxide. Moreover, in some embodiments, the rare earth composition-containing commonly has at least about 20,000 ppm cerium (III), more commonly at least about 100,000 ppm cerium (III) and even more commonly at least about 250,000 ppm cerium (III).

In some formulations, the molar ratio of cerium (III) to cerium (IV) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Moreover, in some formulations the molar ratio of cerium (IV) to cerium (III) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Further, these molar ratios apply for any combinations of soluble and insoluble forms of Ce(III) and soluble and insoluble forms of Ce(IV).

In some formulations, the insoluble forms of cerium are derived from cerium precipitation process. In other formulations, an insoluble and/or sintered cerium-containing compound can be derived from a cerium carbonate, a cerium oxalate, a cerium nitrate, a cerium acetate, a cerium acetylacetone, a cerium bromide, a cerium chloride, a cerium ethylhexanoate, a cerium fluoride, a cerium sulfate, a cerium iodide, a cerium hydroxide, hydrates thereof, ammonium, potassium, and/or sodium salts thereof, and mixtures thereof. In some embodiments, the insoluble and/or sintered cerium-containing compound can be prepared by thermally decomposing a cerium carbonate, cerium oxalate, cerium nitrate or cerium acetate at a temperature between about 250 degrees Celsius and about 350 degrees Celsius in a furnace in the presence of air. The temperature and pressure conditions may be altered depending on the composition of the cerium-containing starting materials and the desired physical properties of the insoluble cerium-containing compound. In some embodiments, the insoluble rare earth-containing composition can be prepared by thermally decomposing a rare earth-containing composition at a temperature between about 250 degrees Celsius and about 350 degrees Celsius in a furnace in the presence of air. Moreover, in some embodiments, an insoluble form of cerium can be derived by a thermal decomposition of an insoluble rare earth-containing composition and/or rare earth particles in the presence of at least some water moisture and/or steam. Preferably, the thermal decomposition is commonly at a temperature from about 100 to about 200 degrees Celsius, more commonly at a temperature from about 110 to about 180 degrees Celsius, even more commonly at a temperature from about 120 to about 170 degrees Celsius, or yet even more commonly at a temperature from about 110 to about 150 degrees Celsius.

In some embodiments, rare earth particles comprise an insoluble rare earth-containing composition containing an insoluble cerium-containing compound. The insoluble cerium-containing compound can be a cerium oxide such as CeO₂, Ce₂O₃, lanthanum oxide, cerium carbonate, lanthanum carbonate, or a mixture thereof. Preferably, the cerium oxide comprises cerium dioxide, CeO₂. In some formulations, the cerium oxide may contain other rare earths (such as, but not limited to one or more of lanthanum, praseodymium, yttrium, scandium, neodymium, samarium, europium, gadolinium, terbium, dysprosium, holmium, erbium, thulium, ytterbium and lutetium).

In one formulation, the rare earth particles comprise a rare earth and/or rare earth-containing composition comprising at least some water-insoluble cerium (IV) and water-soluble cerium (III) and/or lanthanum (III). The rare earth and/or rare earth-containing composition comprise at least some water-soluble cerium (III), typically in the form of water-soluble cerium (III) salt. Commonly, the rare earth particles comprises more than about 1 wt % of a water-soluble cerium (III) composition, more commonly more than about 5 wt % of a water-soluble cerium (III) composition, even more commonly more than about 10 wt % of a water-soluble cerium (III) composition, yet even more commonly more than about 20 wt % of a water-soluble cerium (III) composition, still yet even more commonly more than about 30 wt % of a water-soluble cerium (III) composition, or still yet even more commonly more than about 40 wt % of a water-soluble cerium (III) composition.

In accordance with some formulations, the rare earth particles typically comprise more than about 50 wt % of a water-soluble cerium (III) composition, more typically the rare earth-containing additive comprises more than about 60 wt % of a water-soluble cerium (III) composition, even more typically the rare earth-containing additive comprises more than about 65 wt % of a water-soluble cerium (III) composition, yet even more typically the rare earth particles comprise more than about 70 wt % of a water-soluble cerium (III) composition, still yet even more typically the rare earth particles comprise more than about 75 wt % of a water-soluble cerium (III) composition, still yet even more typically the rare earth particles comprise more than about 80 wt % of a water-soluble cerium (III) composition, still yet even more typically the rare earth particles comprise more than about 85 wt % of a water-soluble cerium (III) composition, still yet even more typically the rare earth particles comprise more than about 90 wt % of a water-soluble cerium (III) composition, still yet even more typically the rare earth particles comprise more than about 95 wt % of a water-soluble cerium (III) composition, still yet even more typically the rare earth particles comprise more than about 98 wt % of a water-soluble cerium (III) composition, still yet even more typically the rare earth particles comprise more than about 99 wt % of a water-soluble cerium (III) composition, or yet still eve more typically comprises about 100 wt % of a water-soluble cerium (III) composition.

Having a mixture of +3 and +4 cerium, preferably in the form of cerium (III) and cerium (IV), can be advantageous. Preferred, non-limiting examples of cerium (IV) compositions are cerium (IV) dioxide, cerium (IV) oxide, cerium (IV) oxyhydroxide, cerium (IV) hydroxide, and hydrous cerium (IV) oxide. For example, having cerium (III) provides for the opportunity to take advantage of cerium (III) sorption and/or precipitation chemistries, such as, but not limited to, the formation of insoluble cerium (III) compositions. Furthermore, having a cerium (IV) composition presents, provides for the opportunity to take advantage of sorption and oxidation/reduction chemistries of cerium (IV), such as, the strong interaction of cerium (IV) with compositions such as phosphorus-containing materials having multiple oxidation states. Commonly, cerium (IV) is also referred to as cerium (+4) and/or ceric.

In some formulations, the rare earth particles have at least some water-soluble rare earth-containing composition. Typically, the water-soluble rare earth-containing composition comprises a rare earth having a +3 oxidation state. Non-limiting examples of suitable water-soluble rare earth-containing compositions include rare earth chlorides, rare earth bromides, rare earth iodides, rare earth astatides, rare earth nitrates, rare earth sulfates, rare earth oxalates, rare earth perchlorates, rare earth carbonates, and mixtures thereof. In one formulation, the rare earth-containing additive includes water-soluble cerium (III) and lanthanum (III) compositions. In some applications, the water-soluble cerium composition comprises cerium (III) chloride, CeCl₃. Commonly, cerium (III) is also referred to as cerium (+3) and/or cerous. More preferably, the rare earth particles comprise a water-soluble cerium +3 composition. Non-limiting examples of suitable water-soluble cerium +3 compositions are cerium (III) chloride, cerium (III) nitrate, cerium (III) sulfate, cerium (III) oxalate, and a mixture thereof.

In some formulations, the rare earth particles may comprise in addition to cerium (IV) one or more rare earths other than cerium. The rare earths other than cerium include cerium yttrium, scandium, lanthanum, praseodymium, neodymium, samarium, europium, gadolinium, terbium, dysprosium, holmium, erbium, thulium, ytterbium, and lutetium. The other rare earths may and may not be water-soluble. Preferably, the other rare earths are in the form of water-insoluble rare earths. Moreover, in some formulations, the rare earth particles may comprise in addition to cerium (IV), cerium (III), preferably one or more water-insoluble forms of cerium (III).

In some formulations, the rare earth, rare earth-containing composition and/or rare earth particle contains water-soluble cerium (III) and one or more other water-soluble trivalent rare earths (such as, but not limited to, one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the rare earth, rare earth-containing composition and/or rare earth particle contains cerium (III) and one or more of lanthanum, neodymium, praseodymium and samarium. The rare earth, rare earth-containing composition and/or rare earth particle commonly includes at least about 0.01 wt % of one or more of lanthanum, neodymium, praseodymium and samarium. The rare earth, rare earth-containing composition and/or rare earth particle commonly has on a dry basis no more than about 10 wt % La, more commonly no more than about 9 wt % La, even more commonly no more than about 8 wt % La, even more commonly no more than about 7 wt % La, even more commonly no more than about 6 wt % La, even more commonly no more than about 5 wt % La, even more commonly no more than about 4 wt % La, even more commonly no more than about 3 wt % La, even more commonly no more than about 2 wt % La, even more commonly no more than about 1 wt % La, even more commonly no more than about 0.5 wt % La, and even more commonly no more than about 0.1 wt % La. The rare earth, rare earth-containing composition and/or rare earth particle commonly has on a dry basis no more than about 8 wt % Nd, more commonly no more than about 7 wt % Nd, even more commonly no more than about 6 wt % Nd, even more commonly no more than about 5 wt % Nd, even more commonly no more than about 4 wt % Nd, even more commonly no more than about 3 wt % Nd, even more commonly no more than about 2 wt % Nd, even more commonly no more than about 1 wt % Nd, even more commonly no more than about 0.5 wt % Nd, and even more commonly no more than about 0.1 wt % Nd. The rare earth, rare earth-containing composition and/or rare earth particle commonly has on a dry basis no more than about 5 wt % Pr, more commonly no more than about 4 wt % Pr, even more commonly no more than about 3 wt % Pr, even more commonly no more than about 2.5 wt % Pr, even more commonly no more than about 2.0 wt % Pr, even more commonly no more than about 1.5 wt % Pr, even more commonly no more than about 1.0 wt % Pr, even more commonly no more than about 0.5 wt % Pr, even more commonly no more than about 0.4 wt % Pr, even more commonly no more than about 0.3 wt % Pr, even more commonly no more than about 0.2 wt % Pr, and even more commonly no more than about 0.1 wt Pr. The rare earth, rare earth-containing composition and/or rare earth particle commonly has on a dry basis no more than about 3 wt % Sm, more commonly no more than about 2.5 wt % Sm, even more commonly no more than about 2.0 wt % Sm, even more commonly no more than about 1.5 wt % Sm, even more commonly no more than about 1.0 wt % Sm, even more commonly no more than about 0.5 wt % Sm, even more commonly no more than about 0.4 wt % Sm, even more commonly no more than about 0.3 wt % Sm, even more commonly no more than about 0.2 wt % Sm, even more commonly no more than about 0.1 wt % Sm, even more commonly no more than about 0.05 wt % Sm, and even more commonly no more than about 0.01 wt % Sm. Preferably, at least most, if not substantially all, of each of the cerium (III) and the one or more of lanthanum, neodymium, praseodymium and samarium are water-insoluble. In some embodiments, at some of one the cerium (III) and the one or more of lanthanum, neodymium, praseodymium and samarium is water-soluble.

In other formulations, the rare earth particle contains at least some water-soluble cerium (III) and one or more other water-soluble trivalent rare earths (such as one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In one formulation, the rare earth, rare earth-containing composition and/or rare earth particle consists essentially of a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. The rare earth in this formulation commonly is primarily cerium (III), more commonly at least about 75 mole % of the rare earth content of the rare earth, rare earth-containing composition and/or rare earth particle is cerium (III), that is no more than about 25 mole % of the rare earth, rare earth-containing composition and/or rare earth particle content comprises rare earths other than cerium (III). Even more commonly, the rare earth in this formulation commonly is primarily at least about 80 mole % cerium (III), yet even more commonly at least about 85 mole % cerium (III), still yet even more commonly at least about 90 mole % cerium (III), and yet still even more commonly at least about 95 mole % cerium (III).

Preferably, the rare earth particles comprise one or more water-insoluble rare earth-containing compositions. While not wanting to be limited by example rare earth oxides, oxyhydroxides, and/or hydrous oxides are example of water-insoluble rare earth-containing compositions.

Preferably, the rare earth particles are in the form of one or more of a granule, crystal, and/or crystallite.

In some embodiments, the rare earth particles have: a mean, median, and/or P₉₀ size of about 1 micron or more; a mean and/or median surface area of from about 50 to about 250 m²/g; a mean and/or median pore volume of from about 0.01 to about 0.1 cm³/g; and a mean and/or median pore size of from about 1 to about 10 nm. Moreover, in some formulations, the rare earth particles have: a mean, median, and/or P₉₀ size of less than about 1 micron; a mean and/or median surface area of from about 5 to about 80 m²/g; a mean and/or median pore volume of from about 0.01 to about 1 cm³/g; and a mean and/or median pore size of from about 5 to about 30 nm.

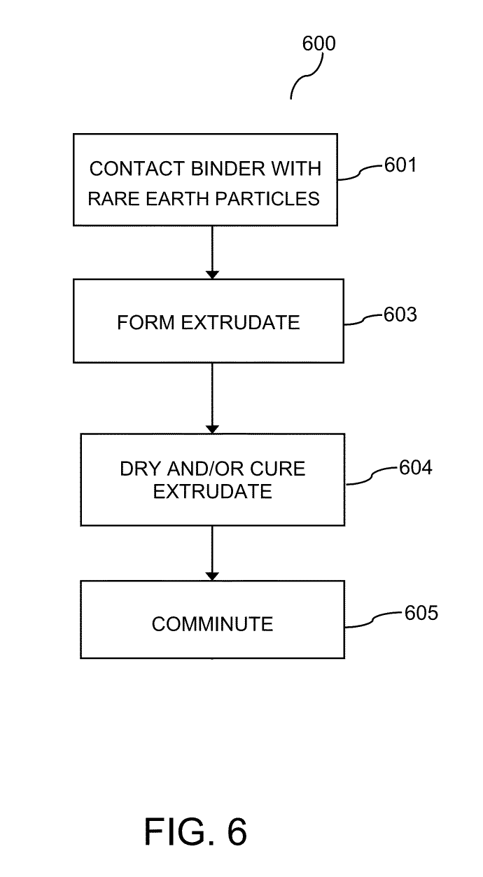

In some embodiments, the rare particles are in the form of agglomerated rare earth particles. FIG. 6 depicts embodiments of a process 600 for making agglomerated rare earth particles. The agglomerated rare earth particles can be in the form of a bead, sphere, box, cylinder, and the like. In step 601, a binder is contacted with rare earth to form a binder mixture. The rare earth particles can be any substantially water-insoluble rare earth-containing composition, preferably the rare earth particles comprise one or more of cerium oxide, cerium (IV) oxide, cerium (III) oxide, cerium carbonate, and lanthanum oxide.

In step 603, an extrudate is formed. Extruding the binder mixture through an extrusion screen or die under an applied pressure forms the extrudate. Preferably, an extruder applies the pressure that forces the binder mixture through the extrusion screen or die. While not wanting to limited by example, the extruder can be a single or multiple screws, an auger, direct, indirect, hydrostatic, a basket, single dome, twin dome, and/or radial extruder. Preferably, the extruder is one of a basket, single dome, twin dome or radial extruder. Preferably, the extrusion process is a low-pressure extrusion process. Low-pressure extruders typically form the extrudate by pushing, scraping, and/or mechanically applying pressure to the binder mixture to force the binder mixture through the extrusion screen or die. While not wanting to be limited by theory, the low-pressure extrusion process substantially reduces and/or minimizes damage to the rare earth particles during extrusion. More specifically, the low-pressure extrusion process substantially reduces damage to the rare earth particles, such as, but not limited to cerium oxide, lanthanum oxide, cerium carbonate, cerium (IV) oxide and/or cerium (III) oxide during extrusion of the binder mixture.

Step 604 may optionally include extruding the strands into a heated environment to dry and/or cure the strands. In some embodiments, the heated environment can include one or more stages having differing temperatures, as for example one or more stages for drying and one or more additional stages for curing. The heated environment can be formed by any method that achieves heating the extruded strands. While not wanting to be limited by example, suitable methods include radiant heating, infrared heating, microwave heating, heating achieved by circulating a hot fluid, and/or heating in an oven (non-limiting examples of suitable ovens include static, conveying or convention), fixed or fluidized bed, or tube, to name a few. In some embodiments, the heated environment is in the form of heated air. The heated air may or may not be circulating heated air. It can be appreciated that the heated environment can assist in one or both of curing the one or more polymeric materials and/or drying the extrudate when the binder mixture comprises at least one of a solution liquid, emulsion, water or a combination thereof.

It can be appreciated that in some embodiments, monitoring and controlling the relative humidity of the heated environment can control the rate and level of water removal from the extruded strands. The rate and amount of water removal from the extruded strands can affect one or both of strand strength and/or porosity. While not wanting to be limited by theory, it is believed that water removal, particularly controlled water removal, opens fluid flow pathways in the strand, and ultimately fluid flow in pathways the rare earth-containing agglomerates. Furthermore, it is believed that controlling water removal during the drying step can provide dried strands, and ultimately rare earth-containing agglomerates, with one or more of higher porosities, pore volumes, and/or pore sizes. While not wanting to limited by theory, it is believed that one or more of the fluid pathway, porosities, pore size, and/or pore volume are significant contributors to one or both of contaminant removal by the rare earth-containing agglomerate and efficiency in treating large volumes of contaminant-containing fluid rapidly. Furthermore, while not wanting to be bound by any theory, it is believed that the one or both of drying and curing of the extrudated strands containing a rare earth carbonate, such as but not limited to cerium carbonate and/or lanthanum carbonate, can convert at least some of the rare earth carbonate to a rare earth oxide, such as cerium oxide and/or lanthanum oxide.

In some embodiments, the heated environment can be monitored and/or maintained to a relative humidity of typically no more than about 100%, more typically no more than about 95%, even more typically no more than about 90%, yet even more typically no more than about 80%, still yet even more typically no more than about 70%, still yet even more typically no more than about 60%, still yet even more typically no more than about 50%, still yet even more typically no more than about 40%, still yet even more typically no more than about 30%, still yet even more typically no more than about 20%, still yet even more typically no more than about 10%, or still yet even more typically no more than about 2%. In some embodiments, the relative humidity is from about 70 to about 100%, preferably from about 80 to 95%. More preferably, the relative humidity is typically greater than about 70%, more typically greater than about 80%, even more typically greater than about 85%, yet even more typically greater than about 90%, or still yet even more typically greater than about 100%.

The heated environment temperature is typically no more than about 250 degrees Celsius, more typically no more than about 240 degrees Celsius, even more typically no more than about 230 degrees Celsius, yet even more typically no more than about 220 degrees Celsius, still yet even more typically no more than about 210 degrees Celsius, still yet even more typically no more than about 200 degrees Celsius, still yet even more typically no more than about 200 degrees Celsius, still yet even more typically no more than about 190 Celsius, still yet even more commonly no more than about 180 degrees Celsius, still yet even more commonly no more than about 170 degrees Celsius, still yet even more commonly no more than about 160 degrees Celsius, still yet even more commonly no more than about 150 degrees Celsius, still yet even more commonly no more than about 140 degrees Celsius, still yet even more commonly no more than about 130 degrees Celsius, still yet even more commonly no more than about 120 degrees Celsius, still yet even more commonly no more than about 110 degrees Celsius, still yet even more commonly no more than about 100 degrees Celsius, still yet even more commonly no more than about 90 degrees Celsius, still yet even more commonly no more than about 80 degrees Celsius, or still yet even more commonly no more than about 70 degrees Celsius.

Preferably, the heated environment temperature is commonly from about 100 to about 250 degrees Celsius, more commonly from about 105 to about 200 degrees Celsius, even more commonly from about 110 to about 190 degrees Celsius, yet even more commonly from about 120 to about 170 degrees Celsius, or still yet even more commonly from about 130 to about 150 degrees Celsius.

In step 605, the dried and/or cured strands are comminuted to form agglomerated rare particles. The comminuting of dried and/or cured strands may be conducted by any suitable comminution process and/or method. Non-limiting examples of suitable comminuting processes and/or methods include shaking, grinding, pulverizing, rubbing, crushing, breaking, or such of the dried and/or cured strands. Preferably in some embodiments, the comminuting process comprises breaking the dried and/or cured strands by vibration or by use of an attrition media, such as nylon brushes or ceramic balls, during the comminuting process. In some embodiments, the comminuting process includes a comminuting screen containing apertures.

In some embodiments, the agglomerated rare earth particles commonly have from about 90 to about 99.9 wt % rare earth-containing particles, more commonly from about 95 to about 99.5 wt % rare earth-containing particles, and even more commonly from about 97 to about 99 wt % rare earth-containing particles. In some embodiments, the agglomerated rare earth particles have about 98 wt % rare earth-containing particles.

It can be appreciated that in some embodiments, the rare earth particles may be in the form of agglomerated rare earth particles substantially free of a binder. While not wanting to be bound by any theory, the binder-free agglomerated rare earth particles may comprise rare earth particles agglomerated due one or more attractive force, such as but not limited to electrostatic forces or the like. Generally, the term agglomerated rare earth particles can refer to rare particles agglomerated with or without a binder.

In accordance with some embodiments, the rare earth particles, individually or in the form agglomerated rare earth particles, commonly have a mean, median and/or P₉₀ particle size of less than about 1 nanometer, more commonly a mean, median and/or P₉₀ particle size from about 1 nanometer to about 1,000 nanometers, even more commonly a mean, median and/or P₉₀ particle size from about 1 micron to about 1,000 microns, or yet even more commonly a mean, median and/or P₉₀ particle size of at least about 1,000 microns.

Preferably, the rare earth particles, individually or in the form of agglomerated rare earth particles, have a mean, median and/or P₉₀ particle size from about 0.1 to about 1,000 nm, more preferably from about 0.1 to about 500 nm. Even more preferably, the rare earth particles comprise cerium (IV) and, individually or in the form of agglomerated rare earth particles, have a mean, median and/or P₉₀ particle size from about 0.2 to about 100 nm.

In accordance with some embodiments, the rare earth particles have an average or mean surface area typically of at least about 1 m²/g. Commonly, the rare earth particles have an average or mean surface area of at least about 70 m²/g. Moreover, the rare earth particles, individually and/or in the form of agglomerated rare earth particles, may have an average or mean surface area of at least about 5 m²/g, in other cases have an average or mean surface area of at least about 10 m²/g, in other cases have an average or mean surface area of at least about 70 m²/g, in yet other cases have an average or mean surface area of at least about 85 m²/g, in still yet other cases have an average or mean surface area of at least about 100 m²/g, in still yet other cases have an average or mean surface area of at least about 115 m²/g, in still yet other cases have an average or mean surface area of at least about 125 m²/g, in still yet other cases have an average or mean surface area of at least about 150 m²/g, in still yet other cases have an average or mean surface area of at least 300 m²/g, and in still yet other cases have an average or mean surface area of at least about 400 m²/g. In some configurations, the rare earth particles, individually and/or in the form of agglomerated rare earth particles commonly can have an average or mean surface area from about 50 to about 500 m²/g, or more commonly have an average or mean surface area from about 110 to about 250 m²/g. In some embodiments, the rare earth particles have an average and/or mean surface area from about 25 m²/g to about 500 m²/g. In addition, it is envisioned that the rare earth particles individually and/or aggregated with higher surface areas will be more effective than those will lower surface areas. Moreover, one skilled in the art will recognize that, the surface area of the rare earth particles individually and/or aggregated may impact the fluid flow dynamics of the fluid. As a result, there may be a need to balance benefits that are derived from increased surface areas with disadvantages such as pressure drop that may occur.

In some formulations, the rare earth particles, individually or in the form of agglomerated rare earth particles, can have an average particle size ranging from the sub-micron, to micron or greater than micron. Commonly the rare earth particles, individually or in the form of agglomerated rare earth particles, have an average or mean particle size from about 1 nanometer to about 1,000 nanometers. In some embodiments, the rare earth particles, individually or in the form of agglomerated rare earth particles, have an average or mean particle size less than about 1 nanometer. In yet other embodiments, the rare earth particles, individually or in the form of agglomerated rare earth particles, have an average or mean particle size from about 1 micrometer to about 1,000 micrometers.

In some embodiments, the one or more of the mean, median and P₉₀ rare earth particle size is commonly from about 1 to about 100 microns, more commonly from about 3 to about 75 microns, even more commonly from about 5 to about 75 microns, yet even more commonly 5 to 65 microns, still yet even more commonly from about 10 to about 60 microns, or still yet even more commonly from about 15 to about 50 microns.

In some embodiments, the rare earth particles have a mean and/or median pore size and/or diameter (hereinafter referred to as pore size). The mean and/or median pore size commonly can be more than about 1 nm, more commonly more than about 2 nm, even more commonly more than about 3 nm, yet even more commonly more than about 5 nm, still yet even more commonly more than about 8 nm, still yet even more commonly more than about 10 nm, still yet even more commonly more than about 12 nm, still yet even more commonly more than about 14 nm, still yet even more commonly more than about 16 nm, still yet even more commonly more than about 18 nm, still yet even more commonly more than about 20 nm or still yet even more commonly more than about 24 nm.

In some embodiments, the rare earth particles comprise predominantly cerium dioxide. Preferably, the rare earth particles comprise nano-crystalline particles of cerium dioxide. The nano-crystalline particles typically have relatively high surface areas. Commonly, the nano-crystalline particles have a surface area of at least about 10 m²/g, more commonly at least about 50 m²/g, and even more commonly at least about 100 m²/g. The maximum surface area typically is no more than about 250 m²/g, more typically no more than about 175 m²/g, and even more typically no more than about 150 m²/g. In some formulations, particularly with smaller nano-crystalline particles (typically less than 100 nanometer-sized particles), the surface area can be as low as 15 m²/g while still maintaining acceptable performance.

In some embodiments the rare earth particles have a mean, median and/or P₉₀ particle size of about 1 micron or more. Preferably, the rare earth particles having a particle size of about 1 micron or more have a mean and/or median pore size of commonly from about 1 to about 10 nm, more commonly from about 2 to about 8 nm, even more commonly from about 3 to about 7 nm, or yet even more commonly from about 4 to about 6 nm and a mean and/or median volume size of commonly from about 0.01 to about 0.10 cm³/g, more commonly from about 0.02 to about 0.08 cm³/g, even more commonly from about 0.03 to about 0.07 cm³/g, or yet even more commonly from about 0.4 to about 0.06 cm³/g.

Moreover in some embodiments the rare earth particles have a mean, median and/or P₉₀ size from of commonly less than about 1 micron. Preferably, the rare earth particles having a particle size of about 1 micron or less have an agglomerate mean and/or median pore size of commonly from about 5 nm to about 30 nm, more commonly from about 10 nm to about 25 nm, even more commonly from about 16 nm to about 20 nm, or yet even more commonly from about 17 nm to about 19 nm and a mean and/or median volume size of commonly from about 0.01 cm³/g to about 0.9 cm³/g, more commonly from about 0.03 to about 0.7 cm³/g, even more commonly from about 0.05 to about 0.5 cm³/g, or yet even more commonly from about 0.1 to about 0.3 cm³/g.

In some embodiments, the rare earth particles are solid particles having at least one of a median, P₉₀, or mean size commonly of at least about 100 microns, more commonly of at least about 250 microns, more commonly of at least about 500 microns, even more commonly of at least about 750 microns, yet even more commonly of at least about 1 mm, still yet even more commonly of at least about 5 mm, still yet even more commonly of at least about 7.5 mm, and still yet even more commonly of at least about 10 mm. In some embodiment, where the binder comprises particles the rare earth particles and the binder particles can have substantially about the same size. The binder particles can be particles suspended in a binder emulsion or solid powder particles.

In some embodiments, the rare earth particles have a mean and/or median pore volume. The mean and/or median pore volume of the rare earth particles is typically at least about 0.02 cm³/g, more typically at least about 0.04 cm³/g, even more typically at least about 0.06 cm³/g, yet even more typically at least about 0.08 cm³/g, still yet even more typically at least about 0.1 cm³/g, still yet even more typically at least about 0.2 cm³/g, still yet even more typically at least about 0.3 cm³/g, still yet even more typically at least about 0.5 cm³/g, or still yet even more typically at least about 1 cm³/g.

In some formulations, the rare earth particles comprise one or more nitrogen-containing materials. The one or more nitrogen-containing materials, commonly, comprise one or more of ammonia, an ammonium-containing composition, a primary amine, a secondary amine, a tertiary amine, an amide, a cyclic amine, a cyclic amide, a polycyclic amine, a polycyclic amide, and combinations thereof. The nitrogen-containing materials are typically less than about 1 ppm, less than about 5 ppm, less than about 10 ppm, less than about 25 ppm, less than about 50 ppm, less about 100 ppm, less than about 200 ppm, less than about 500 ppm, less than about 750 ppm or less than about 1000 ppm of the rare earth particle.

In one application, the rare earth particles and/or agglomerated rare earth particles comprise cerium (IV), typically as cerium (IV) oxide. The weight percent (wt %) cerium (IV) content based on the total rare earth content of the rare earth particles typically is at least about 50 wt % cerium (IV), more typically at least about 60 wt % cerium (IV), even more typically at least about 70 wt % cerium (IV), yet even more typically at least about 75 wt % cerium (IV), still yet even more typically at least about 80 wt % cerium (IV), still yet even more typically at least about 85 wt % cerium (IV), still yet even more typically at least about 90 wt % cerium (IV), still yet even more typically at least about 95 wt % cerium (IV), and even more typically at least about 99 wt % cerium (IV). Preferably, the rare earth particles are substantially devoid of rare earths other than cerium (IV). More preferably, the weight percent (wt %) cerium (IV) content based on the total rare earth content of the rare earth particles is about 100 wt % cerium (IV) and comprises one or more of cerium (IV) oxide, cerium (IV) hydroxide, cerium (IV) oxyhydroxyl, cerium (IV) hydrous oxide, cerium (IV) hydrous oxyhydroxyl, CeO₂, and/or Ce(IV)(O)_{w}(OH)ₓ(OH)_{y}.zH₂O, where w, x, y and z can be zero or a positive, real number.

### Activated Carbon

Activated carbon refers to highly porous carbon having a random or amorphous structure. Typically, the activated carbon is derived from bituminous or other forms of coal, pitch, bones, nut shells, coconut shells, corn husks, polyacrylonitrile (PAN) polymers, charred cellulosic fibers or materials, wood, and the like. The activated carbon may be derived from any source, such as from bituminous coal or other forms of coal, or from pitch, bones, nut shells, coconut shells, corn husks, polyacrylonitrile (PAN) polymers, charred cellulosic fibers or materials, wood, and the like. The activated carbon can, for example, be formed directly by activation of coal or other materials, or by grinding carbonaceous material to a fine powder, agglomerating it with pitch or other adhesives, and then converting the agglomerate to activated carbon. Coal-based or wood-based activated carbon can be used in combination or separately, e.g., 90% coconut carbon and 10% bituminous carbon.

In accordance with some embodiments, the activated carbon has a specific surface area of at least about 2,000 m²/g. The porosity of the activated carbon ranges from about 2 to about 50 nm. The activated carbon can have any particle size. Preferred particle size ranges from about 100 mm or less, more preferred particle sizes are about 50 mm or less. In one embodiment, the activated carbon particles have a particle size of less than about 1.0 mm.

In some formulations, the activated carbon particles have a high crystalline orientation. Preferably, the activated carbon particles have an average particle size from about 5 to about 500 nm, more preferably the particle size is from about 15 to about 50 nm, and even more preferably the average particle size is from about 20 to about 40 nm. In some embodiments, the activated carbon particles form activated carbon aggregates, the activated carbon aggregates commonly have a size of at least about 20 nm, more commonly an aggregate size from about 50 to about 2,000 nm.

The activated carbon surface area ranges from about 30 to about 2,500 square meters per gram. In a preferred embodiment, the surface area of the activated carbon is from about 65 to about 300 square meters per gram.

In some embodiments, the activated carbon comprises particles have about an 80×325 U.S. mesh size. In other embodiments, the mesh size of the activated carbon is about an 80×200 U.S. mesh. In other embodiments, the mesh size of the activated carbon is about 50×200 U.S. mesh.

In some formulations, the activated carbon has a mean or average particle size commonly from about 40 to about 300 μm, more commonly a mean or average particle size from about 40 to about 300 μm, even more commonly a mean or average particle size form about 70 to 300 μm, yet even more commonly a mean or average particle size from about from about 150 to about 200 μm. In other formulations, the activated carbon has a mean or average particle size less than about 40 μm.

In some embodiments, the mesh size of the activated carbon particles preferably have one of the following particle size distributions:

d(0.1)=18.6um, d(0.5)=87.1um, and d(0.9)=191.3um; or

d(0.1)=15.5um, d(0.5)=73.8um, and d(0.9)=154.3um.

In some embodiments, the mesh size of the activated carbon is about 80×200 U.S. mesh. In other embodiments, the mesh size of the activated carbon is about 50×200 U.S. mesh. In some configurations, the activated carbon has an average particle size such that it can pass through a screen of 350 mesh or less (e.g., an average particle size of less than about 350 mesh—about 40 μm). In some configurations, the activated carbon particles have a mean and/or average particle size from about 70 to about 220 μm. In other configurations, the activated carbon particles have a mean and/or average particle size from about 70 to about 90 μm.

### Binder

The binder is a material that promotes cohesion of the activated carbon particles and the rare earth particles. The binder may comprise one or more polymers generally categorized as thermoset, thermoplastic, elastomer, or a combination thereof as well as cellulosic polymers and glasses. Suitable binders include both naturally occurring and synthetic polymers, as well as synthetic modifications of naturally occurring polymers. The binders described herein are likewise suitable for forming agglomerated rare earth particles.

Preferably, the binder is a polymeric and/or thermoplastic material that is capable of softening and becoming tacky at an elevated temperature and hardening when cooled. Thermoplastic binders include, but are not limited to, end-capped polyacetals, such as poly(oxymethylene) or polyformaldehyde, poly(trichloroacetaldehyde), poly(n-valeraldehyde), poly(acetaldehyde), poly(propionaldehyde), and the like; cellulose acetate butyrates, acrylic resins, acrylic polymers, such as polyacrylamide, poly(acrylic acid), poly(methacrylic acid), poly(ethyl acrylate), poly(methyl methacrylate), and the like; fluorocarbon polymers, such as poly(tetrafluoroethylene), perfluorinated ethylene-propylene copolymers, ethylene-tetrafluoroethylene copolymers, poly(chlorotrifluoroethylene), ethylene-chlorotrifluoroethylene copolymers, poly(vinylidene fluoride), poly(vinyl fluoride), and the like; polyamides, such as poly(6-aminocaproic acid) or poly(.epsilon.-caprolactam), poly(hexamethylene adipamide), poly(hexamethylene sebacamide), poly(11-aminoundecanoic acid), and the like; polyaramides, such as poly(imino-1,3-phenyleneiminoisophthaloyl) or poly(m-phenylene isophthalamide), and the like; parylenes, such as poly-p-xylylene, poly(chloro-p-xylylene), and the like; polyarylene oxides; polyarylates; polyaryl ethers, such as poly(oxy-2,6-dimethyl-1,4-phenylene) or poly(p-phenylene oxide), and the like; polysulfones; polyaryl sulfones, such as poly(oxy-1,4-phenylenesulfonyl-1,4-phenyleneoxy-1,4-phenylene-isopropylid-ene-1,4-phenylene), poly-(sulfonyl-1,4-phenyleneoxy-1,4-phenylenesulfonyl-4,4′-biphenylene), and the like; polycarbonates, such as poly(bisphenol A) or poly(carbonyldioxy-1,4-phenyleneisopropylidene-1,4-phenylene), and the like; polyesters, such as poly(ethylene terephthalate), poly(tetramethylene terephthalate), poly(cyclohexylene-1,4-dimethylene terephthalate) or poly(oxymethylene-1,4-cyclohexylenemethyleneoxyterephthaloyl), and the like; polyaryl sulfides, such as poly(p-phenylene sulfide) or poly(thio-1,4-phenylene), and the like; polyimides, such as poly(pyromellitimido-1,4-phenylene), and the like; polyolefins, such as polyethylene, LDPE, LLDPE, HDPE, polyethylene copolymers with other polyolefins, polypropylene, poly(1-butene), poly(2-butene), poly(1-pentene), poly(2-pentene), poly(3-methyl-1-pentene), poly(4-methyl-1-pentene), and the like; vinyl polymers, such as poly(vinyl acetate), poly(vinylidene chloride), poly(vinyl chloride) both plasticized and unplasticized, polyvinlyl halides, polyvinyl esters, polyvinyl ethers, polyvinyl sulfates, polyvinyl phosphates, polyvinyl amines and the like; diene polymers, such as 1,2-poly-1,3-butadiene, 1,4-poly-1,3-butadiene, polyisoprene, polychloroprene, and the like; polystyrenes; copolymers of the foregoing, such as acrylonitrile-butadiene-styrene (ABS) copolymers, and the like; polyoxidiazoles; polytriazols; polycarbodiimides; phenol-formaldehyde resins; melamine-formaldehyde resins; formaldehydeureas; and the like; co-polymers and block interpolymers thereof; and derivatives and combinations thereof.

The thermoplastic binders further include ethylenevinyl acetate copolymers (EVA), ultra-high molecular weight polyethylene (UHMWPE), very high molecular weight polyethylene (VHMWPE), nylon, polyethers such as polyethersulfone, ethylene-acrylic acid copolymer, ethylene-methacrylic acid copolymer, ethylene-methylacrylate copolymer, polymethylmethacrylate, polyethylmethacrylate, polybutylmethacrylate, and copolymers/mixtures thereof.

In general, polymers have a melt temperature between about 50° C. and about 500° C., more particularly, between about 75° C. and about 35° C., even more particularly between about 80° C. and about 200° C. Non-limiting examples can include polyolefins that soften or melt in the range from about 85° C. to about 180° C., polyamides that soften or melt in the range from about 200° C. to about 300° C., and fluorinated polymers that soften or melt in the range from about 300° C. to about 400° C.

In some embodiments, the binder comprises a low melt index polymeric material. A low melt index polymer has a melt index value less than 1.8 g/10 min., as determined by ASTM D 1238 at 190 degrees Celsius and 15 kg load. Non-limiting examples of low melt index polymeric materials are ultra high and very high molecular weight polyethylene.

Suitable thermosetting polymers include, but are not limited to, polyurethanes, silicones, fluorosilicones, phenolic resins, melamine resins, melamine formaldehyde, and urea formaldehyde.

Suitable elastomers can include, but are not limited to, natural and/or synthetic rubbers, like styrene-butadiene rubbers, neoprenes, nitrile rubber, butyl rubber, silicones, polyurethanes, alkylated chlorosulfonated polyethylene, polyolefins, chlorosulfonated polyethylenes, perfluoroelastomers, polychloroprene (neoprene), ethylene-propylene-diene terpolymers, chlorinated polyethylene, fluoroelastomers, and ZALAK™ (Dupont-Dow elastomer).

In some embodiments the binder comprises a mixture of two or more binders, preferably in the form of an emulsion. In one exemplary formulation, the binder comprises a mixture of two binder emulsions sold under the trade name of AQUATEC10206™ manufactured by Arkema Inc. and PICASSIAN XL-702™ manufactured by Picassian Polymers. In another exemplary formulation, the binder comprises an acrylic emulsion sold under the trade name of Hycar 26288™ manufactured by Lubrizol. In yet another exemplary formulation, the binder comprises a fluoroethylene alkyl vinyl ether copolymer emulsion sold under the trade name of LUMIFLON™ manufactured by Asahi Glass Company.

In some embodiments, where the polymer binder comprises an ethylene vinyl copolymer, the insoluble rare earth-containing compound consists essentially of an anhydrous rare earth-containing compound. Those of skill in the art will realize that some of the thermoplastics listed above can also be thermosets depending upon the degree of cross-linking, and that some of each may be elastomers depending upon their mechanical properties. The categorization used above is for ease of understanding and should not be regarded as limiting or controlling.

Cellulosic polymers can include naturally occurring cellulose such as cotton, paper and wood and chemical modifications of cellulose. In a specific embodiment, the rare earth-containing compound, preferably an insoluble rare earth-containing compound, can be mixed with paper fibers or incorporated directly into paper pulp for forming a paper-based substrate comprising the insoluble rare earth-containing compound. In a preferred embodiment, rare earth-containing compound is sintered prior to incorporation into the paper pulp.

Polymer binders can also include glass materials such as glass fibers, beads and mats. Glass solids may be mixed with particulates of the rare earth composition and/or particles thereof and heated until the solids begin to soften or become tacky so that the rare earth-containing compound adheres to the glass. Similarly, extruded or spun glass fibers may be coated with the rare earth composition and/or particles thereof while the glass is in a molten or partially molten state or with the use of adhesives. Alternatively, the glass composition may be doped with the rare earth composition and/or particles thereof during manufacture. Preferably, the rare earth composition comprises a sintered rare earth composition.

In some applications, water-soluble glasses such as are described in U.S. Pat. Nos. 5,330,770, 6,143,318 and 6,881,766, may be an appropriate polymer binder. The descriptions of such glasses in the noted references are incorporated herein by reference. In other applications, materials that swell through fluid absorption including but not limited to polymers such as synthetically produced polyacrylic acids, and polyacrylamides and naturally-occurring organic polymers such as cellulose derivatives may also be used. Biodegradable polymers such as polyethylene glycols, polylactic acids, polyvinylalcohols, co-polylactideglycolides, and the like may also be used as the polymer binder.

Minerals and clays such as bentonite, smectite, kaolin, dolomite, montmorillinite and their derivatives may also serve as suitable binder or substrate materials.

In some formulations, the binder is a low melt index polymeric material. Low melt index polymeric materials typically have a melt index less than approximately 1.0 g/10 min at 190° C. and 15 kg load. Non-limiting examples of low melt index polymeric materials are VHMWPE and UHMWPE. Low melt index binders typically become tacky when heated. Moreover, they do easily flow when heated. More importantly, low melt index polymer, when mixed with particles (such as, one of activated carbon, rare earth particles and such) become tacky enough to bind particles together. It is believed that low melt index bind the particles together without covering much of the particle surface.

In other formulations, the binder can be a high melt index polymeric material. Preferably, the high melt index polymeric material has a melt index greater than about 1.0 g/10 min. More particularly, high melt index polymeric materials have a melt index greater the one or both of VHMWPE and UHMWPE. Non-limiting examples of high index melt polymeric materials are poly(ethylene-co-acrylic acid) and low density polyethylene. High melt index materials typically melt and flow when heated. High melt index polymers are preferred for forming porous filter blocks.

In some embodiments, the binder comprises binder particles having an average and/or mean particle size commonly from about 5 to about 150 μm, more commonly an average and/or mean particle size from about 100 to about 150 μm and even more commonly an average and/or mean particle size of about 110 μm.

### Filter Block

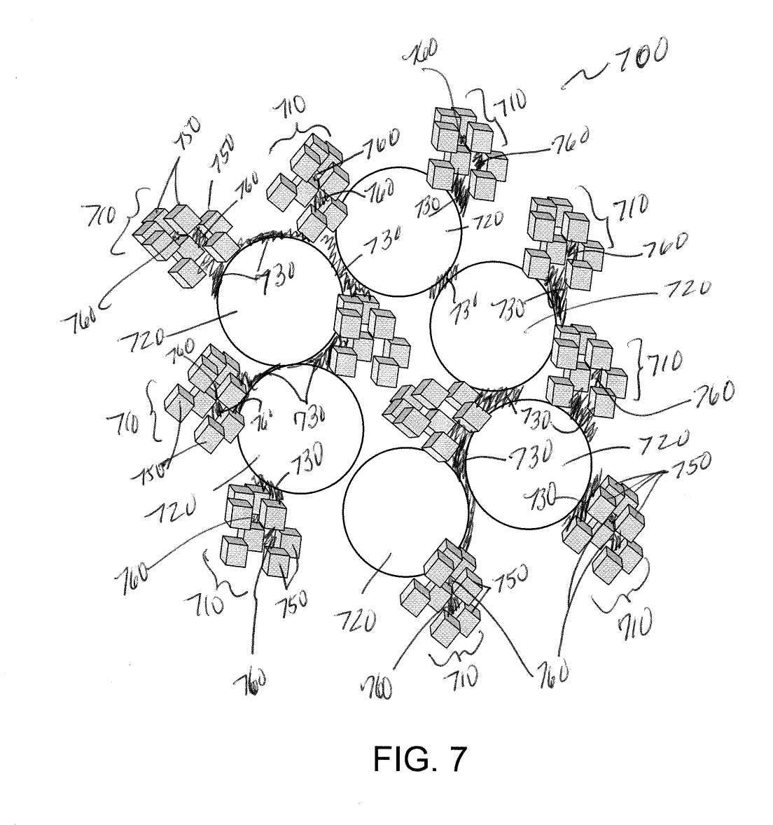

FIG. 7 depicts a filter block 700 in accordance with some embodiments. The filter block 700 comprises agglomerated rare earth particles 710 and activated carbon particles 720 substantially homogeneously intermixed and cohesively bonded together by a binder 730, the agglomerated rare earth particles 710 have a plurality of rare earth particles 750. Preferably, the agglomerated rare earth particles 710 further comprise a polymeric binder 760. In some formulations of the filter block 700, the binder 730 and the polymeric binder 760 differ and wherein at least most of the rare earth particles 750 are in contact with the polymeric binder 760; while in other formulations, the binder 730 and the polymeric binder 760 are the same. Preferably, the binder 730 is one of a thermoset or thermoplastic polymer. The rare earth particles 760 may have an average and/or mean particle size from about 1 nm to about 100 nm. The activated carbon particles 720 may have an average and/or mean particle size from about 40 μm to about 300 μm. In some configurations, the rare earth particles 760 and/or agglomerated rare earth particles 710 may have a surface area of at more than about 5 m²/g and/or an average and/or mean pore volume of at least about 0.02 cm³/g. In some configurations, the agglomerated rare earth particles 710 may have an average and/or mean particle size from about 1 μm to about 1,000 μm. The rare earth particles 750 may be one of cerium oxide, lanthanum oxide, cerium (IV) oxide, cerium (III) oxide, lanthanum (III) oxide, lanthanum carbonate, cerium carbonate, or a mixture thereof. Preferably, the rare earth particles 750 comprise a rare earth carbonate. The filter block may have a shape generally resembling one of a sheet, a film, solid cylinder, or tubular cylinder.

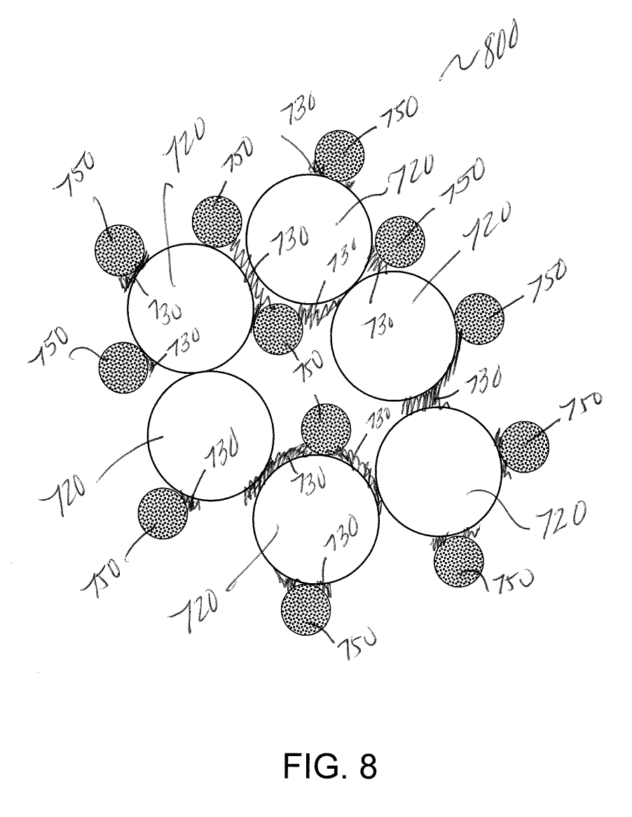

FIG. 8 depicts a filter block 800 in accordance with some embodiments. The filter block 800 comprises rare earth particles 750 and activated carbon particles 720 are substantially homogeneously intermixed and cohesively bonded together by a binder 730. Preferably, the binder 730 is one of a thermoset or thermoplastic polymer. The rare earth particles 760 may have an average and/or mean particle size from about 1 nm to about 100 nm. The activated carbon particles 720 may have an average and/or mean particle size from about 40 μm to about 300 μm. In some configurations, the rare earth particles 760 have a surface area of at more than about 5 m²/g and/or an average and/or mean pore volume of at least about 0.02 cm³/g. In some configurations, the rare earth particles 760 may have an average and/or mean particle size from about 1 μm to about 1,000 μm. The rare earth particles 750 may be one of cerium oxide, lanthanum oxide, cerium (IV) oxide, cerium (III) oxide, lanthanum (III) oxide, lanthanum carbonate, cerium carbonate, or a mixture thereof. Preferably, the rare earth particles 750 comprise a rare earth carbonate. The filter block may have a shape generally resembling one of a sheet, a film, solid cylinder, or tubular cylinder.

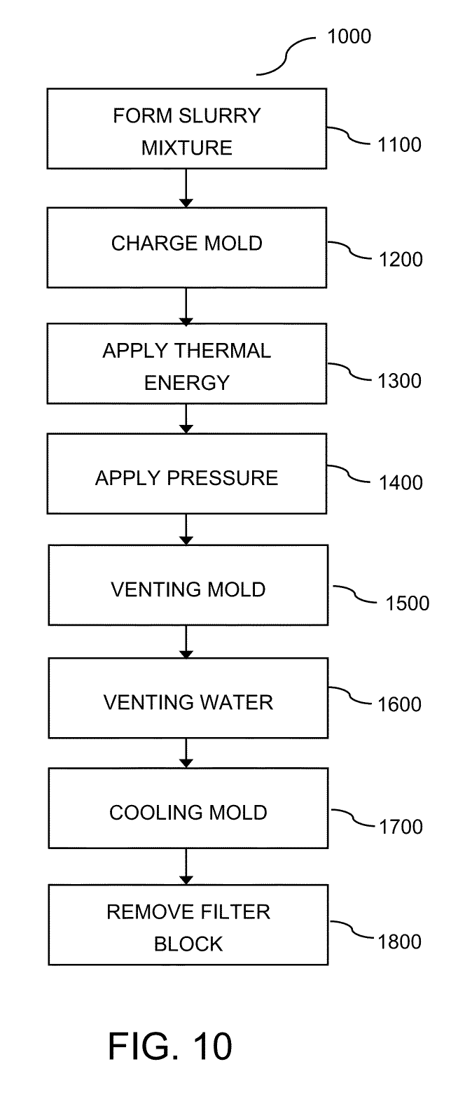

FIG. 10 depicts a process 1000 for making a filter block accordance with some embodiments by forming a slurry mixture (step 1100) comprising activated carbon particles, rare earth particles, and a binder; charging the mixture to a mold (step 1200); applying thermal energy (step 1300) to the mixture to cohesively bind together the activated carbon particles and the rare earth particles to form a filter block; and removing the filter block from the mold (step 1800). Preferably, the slurry mixture is an aqueous slurry mixture. Preferably, the applying thermal energy step raises the temperature of the mixture to one or both of the melt temperature and tackifying temperature of binder. In some configurations, the method may further include, applying pressure (step 1400) to the mixture one or more of before, during, and after the applying of thermal energy to the mixture. Some configurations of the method may further include, venting of mold (step 1500) during one or more of before, during, and after the applying of thermal energy to the mixture. Preferably, the method further includes venting at least some water vapor (step 1600) during at least some of the applying thermal energy step, preferably venting at least some water vapor during at least most of the applying thermal energy step. In some configurations, the method may further include, cooling the mold (step 1700) before the removing the filter block from the mold. Preferably, the binder is one of a thermoset and thermoplastic polymer, more preferably the binder is one of an acrylic polymer, an acrylic co-polymer, a polyethylene polymer, a polyethylene co-polymer, or a combination thereof. In some embodiments, the rare earth particles are in the form of agglomerated rare earth particles.

In accordance with some embodiments, commonly at least 0.000001 g of water vapor are vented per gram slurry mixture during step 1600, more commonly least 0.000005 g of water vapor are vented per gram slurry mixture during step 1600, even more commonly least 0.00001 g of water vapor are vented per gram slurry mixture during step 1600, yet even more commonly least 0.00005 g of water vapor are vented per gram slurry mixture during step 1600, still yet even more commonly least 0.0001 g of water vapor are vented per gram slurry mixture during step 1600, still yet even more commonly least 0.0005 g of water vapor are vented per gram slurry mixture during step 1600, still yet even more commonly least 0.001 g of water vapor are vented per gram slurry mixture during step 1600, still yet even more commonly least 0.005 g of water vapor are vented per gram slurry mixture during step 1600, still yet even more commonly least 0.01 g of water vapor are vented per gram slurry mixture during step 1600, still yet even more commonly least 0.03 g of water vapor are vented per gram slurry mixture during step 1600, still yet even more commonly least 0.05 g of water vapor are vented per gram slurry mixture during step 1600, still yet even more commonly least 0.07 g of water vapor are vented per gram slurry mixture during step 1600, still yet even more commonly least 0.1 g of water vapor are vented per gram slurry mixture during step 1600, still yet even more commonly least 0.15 g of water vapor are vented per gram slurry mixture during step 1600, still yet even more commonly least 0.2 g of water vapor are vented per gram slurry mixture during step 1600, still yet even more commonly least 0.25 g of water vapor are vented per gram slurry mixture during step 1600, still yet even more commonly least 0.3 g of water vapor are vented per gram slurry mixture during step 1600, still yet even more commonly least 0.4 g of water vapor are vented per gram slurry mixture during step 1600, still yet even more commonly least 0.5 g of water vapor are vented per gram slurry mixture during step 1600, or yet still even more commonly least 0.6 g of water vapor are vented per gram slurry mixture during step 1600.

Some embodiments include a contaminant-containing filter block having agglomerated rare earth particles having at least a first contaminant sorbed by at least some of the rare earth particles and activated carbon particles having at least a second contaminant sorbed by at least some of the activated carbon particles. The agglomerated rare earth particles and the activated carbon particles are substantially homogeneously intermixed and cohesively bonded together by a binder, the agglomerated rare earth particles have a plurality of rare earth particles. In some embodiments, the first and second contaminants differ. In some embodiments, the first and second contaminants are the same. The first and second contaminant can be one or more of arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, or a chemical contaminant. Preferably, the agglomerated rare earth particles further comprise a polymeric binder. In some formulations of the filter block, the binder and the polymeric binder differ and wherein at least most of the rare earth particles are in contact with the polymeric binder; while in other formulations, the binder and the polymeric binder are the same. Commonly the rare earth particles sorb at least about 10 mole % of the first contaminant contained in the fluid stream, more commonly at least 20 mole % of the first contaminant contained in the fluid stream, even more commonly at least 30 mole % of the first contaminant contained in the fluid stream, yet even more commonly at least about 40 mole % of the first contaminant contained in the fluid stream, still yet even more commonly at least about 50 mole % of the first contaminant contained in the fluid stream, still yet even more commonly at least about 60 mole % of the first contaminant contained in the fluid stream, still yet even more commonly at least about 70 mole % of the first contaminant contained in the fluid stream, still yet even more commonly at least about 80 mole % of the first contaminant contained in the fluid stream, still yet even more commonly at least about 90 mole % of the first contaminant contained in the fluid stream, still yet even more commonly at least about 95 mole % of the first contaminant contained in the fluid stream, or still yet even more commonly at least about 99 mole % of the first contaminant contained in the fluid stream but typically no more than about 5 mole % of the second contaminant contained in the fluid stream, more typically no more than about 10 mole % of the second contaminant contained in the fluid stream, even more typically no more than about 20 mole % of the second contaminant contained in the fluid stream, yet even more typically no more than about 30 mole % of the second contaminant contained in the fluid stream, still yet even more typically no more than about 40 mole % of the second contaminant contained in the fluid stream, still yet even more typically no more than about 50 mole % of the second contaminant contained in the fluid stream, still yet even more typically no more than about 60 mole % of the second contaminant contained in the fluid stream, or yet still even more typically no more than about 75 mole % of the second contaminant contained in the fluid stream. Typically the activated carbon particles sorb at least about 10 mole % of the second contaminant contained in the fluid stream, more typically at least 20 mole % of the second contaminant contained in the fluid stream, even more typically at least 30 mole % of the second contaminant contained in the fluid stream, yet even more typically at least about 40 mole % of the second contaminant contained in the fluid stream, still yet even more typically at least about 50 mole % of the second contaminant contained in the fluid stream, still yet even more typically at least about 60 mole % of the second contaminant contained in the fluid stream, still yet even more typically at least about 70 mole % of the second contaminant contained in the fluid stream, still yet even more typically at least about 80 mole % of the second contaminant contained in the fluid stream, still yet even more typically at least about 90 mole % of the second contaminant contained in the fluid stream, still yet even more typically at least about 95 mole % of the second contaminant contained in the fluid stream, or still yet even more typically at least about 99 mole % of the second contaminant contained in the fluid stream but commonly no more than about 5 mole % of the first contaminant contained in the fluid stream, more commonly no more than about 10 mole % of the first contaminant contained in the fluid stream, even more commonly no more than about 20 mole % of the first contaminant contained in the fluid stream, yet even more commonly no more than about 30 mole % of the first contaminant contained in the fluid stream, still yet even more commonly no more than about 40 mole % of the first contaminant contained in the fluid stream, still yet even more commonly no more than about 50 mole % of the first contaminant contained in the fluid stream, still yet even more commonly no more than about 60 mole % of the first contaminant contained in the fluid stream, or yet still even more commonly no more than about 75 mole % of the first contaminant contained in the fluid stream.

Some embodiments include a filter block having from about 20 to about 90 wt % activated carbon particles, from about 80 to about 10 wt % rare earth, rare earth-containing composition and/or rare earth particles, and from about 5 to about 50 wt % binder. The binder is substantially interspersed with the activated carbon particles and the rare earth particles and binds the activated carbon and rare earth particles together. In some embodiments the filter block commonly includes at from about 1 wt % activated carbon particles, more commonly from about 5 wt % activated carbon particles, even more commonly from about 10 wt % activated carbon particles, yet even more commonly from about 20 wt % activated carbon particles, still yet even more commonly from about 30 wt % activated carbon particles, still yet even more commonly from about 40 wt % activated carbon particles, still yet even more commonly from about 50 wt % activated carbon particles, still yet even more commonly from about 60 wt % activated carbon particles, still yet even more commonly from about 70 wt % activated carbon particles to commonly about 10 wt % activated carbon particles, commonly from about 20 wt % activated carbon particles, even more commonly from about 30 wt % activated carbon particles, yet even more commonly from about 40 wt % activated carbon particles, still yet even more commonly from about 50 wt % activated carbon particles, still yet even more commonly from about 60 wt % activated carbon particles, still yet even more commonly from about 70 wt % activated carbon particles, still yet even more commonly from about 80 wt % activated carbon particles, still yet even more commonly from about 90 wt % activated carbon particles. In some embodiments the filter block commonly includes at from about 1 wt % rare earth particles, more commonly from about 5 wt % rare earth particles, even more commonly from about 10 wt % rare earth particles, yet even more commonly from about 20 wt % rare earth particles, still yet even more commonly from about 30 wt % rare earth particles, still yet even more commonly from about 40 wt % rare earth particles, still yet even more commonly from about 50 wt % rare earth particles, still yet even more commonly from about 60 wt % rare earth particles, still yet even more commonly from about 70 wt % rare earth particles to commonly about 10 wt % rare earth particles, commonly from about 20 wt % rare earth particles, even more commonly from about 30 wt % rare earth particles, yet even more commonly from about 40 wt % rare earth particles, still yet even more commonly from about 50 wt % rare earth particles, still yet even more commonly from about 60 wt % rare earth particles, still yet even more commonly from about 70 wt % rare earth particles, still yet even more commonly from about 80 wt % rare earth particles, still yet even more commonly from about 90 wt % rare earth particles. In some embodiments, the binder content is commonly from about 5 to about 50 wt %, is more commonly from about 20 to about 45 wt %, or even more commonly form about 35 to about 40 wt %.

In order to minimize the amount of the activated carbon particle and/or rare earth-containing particle surface area covered/blocked by binder, the binder preferably comprises at least one binder having less than or equal to 10 g/min melt index, or, more preferably, 0.1-10 g/min melt index and especially 1-10 g/min melt index by ASTM D1238 or DIN 53735 at 190° C. and 15 kilograms. Binders from these ranges become tacky enough to bind the activated particles and/or rare earth particles together in a solid profile and maintain a high percentage of the activated carbon and/or rare earth-containing particle surface area uncovered/unblocked and available for effective contaminant removal and/or detoxification.

In some embodiments, the overall shape of the filter block may or may not be cylindrical (round in cross-section or end-view) and, instead may be square, oval, triangular, or other shapes in cross-section and/or in end-view. The filter block may be considered a three-dimensional solid profile, which has three dimensions that are preferably on the same order of magnitude. For example, some embodiments may be dimensioned to have an axial length from about ⅓ to about 10 times the diameter of the filter block, more preferably about ⅓ to about 5 times the diameter, and most preferably from about 1 to about 5 times the diameter. In non-cylindrical filter blocks, the axial length is preferably from about ⅓ to about 10 times the width, more preferably from about ⅓ to about 5 times the width, and most preferably from about 1 to about 5 times; and within from about ⅓ to about 10 times the depth, more preferably from about ⅓ to about 5 times the depth, and most preferably from about 1 to about 5 times the depth.

Some embodiments include a filter block and method for making a filter block. The method for the filter block includes the steps of: mixing a binder, activated carbon particles and/or the rare earth particles to form a substantially homogeneous blend; charging the homogeneous blend to a mold; heating the mold to a temperature of from about 175 to about 205 degrees Celsius to form a filter block; optionally comprising the homogenous blend; and removing the filter block from the mold. The optional, but preferred, compression may take place before heating, during heating, and/or after heating. Compression, if performed, is preferably performed at a pressure of less than about 100 psi. The method may include, after heating, cooling the mold before removing the filter block from the mold. The method may further include, after removing step, trimming the filter. Moreover in some embodiments, the processing of the filter block, compression can be applied in order to achieve a more consistent and stronger filter block. Compression can facilitate good contact between activated carbon particles and/or the rare earth particles and the binder by pressing the activated carbon and/or rare earth particles into the binder. Compression can also prevent cracking and shrinkage of the filter block while the filter block is cooling in the mold. Thus, in one embodiment of the invention, a compression that reduces the fill height of the mold in the range of approximately 0%-30% is employed. In some arrangements, the compression reduces the fill height of the mold from about 5% to about 20%, more preferably from about 10% to about 20%. In other arrangements, the compression reduces the fill height of the mold by no more than about 10%. In some configurations, compression is not applied.

Some embodiments include a process for making a filter block comprising: mixing activated carbon particles and rare earth particles and binder to form a mixture; adding the mixture to the mold; heating the mixture in the mold to a temperature, the temperature is from about 100 degrees Celsius to about 600 degrees Celsius to for a filter block; and removing the filter block from the mold.

The binder, the activate carbon particles and rare earth particles are mixed for at least about 15 minutes, more preferably for from about 20 to about 60 minutes before adding the mixture to the mold. The mixing is preferably done in vessels which include an agitator, mixer with dulled impeller blades, ribbon blender, rotary mixer, sigma mixer or any other low shear mixer that does not significantly alter the particle size distribution of one or more of the binder, activated carbon particles, and rare earth particles. Some embodiments include adding a fluid to the mixture during the mixing process. Suitable fluid include, without limitation, water, an organic solute, such as an alcohol. In some embodiments, the amount of fluid is commonly no more than the mass of the activated carbon particles, more commonly no more than the twice the mass of the activated carbon particles, no more than three times the mass of the activated carbon particles, no more than four times the mass of the activated carbon particles, or no more than five times the mass of the activated carbon particles. Preferably, the amount of fluid is from typically from about 0.2 to about two times the mass of the activated carbon particles, more preferably from about 0.5 to about 1.5 times the mass of the activated carbon particles. In some embodiments, the amount of fluid is commonly no more than the combined mass of the activated carbon and rare earth particles, more commonly no more than the twice the total mass of the activated carbon and rare earth particles, no more than three times the total mass of the activated carbon and rare earth particles, no more than four times the total mass of the activated carbon and rare earth particles, or no more than five times the total mass of the activated carbon and rare earth particles. Preferably, the amount of fluid is from typically from about 0.2 to about two times the total mass of the activated carbon and rare earth particles, more preferably from about 0.5 to about 1.5 times the total mass of the activated carbon and rare earth particles.

The mixture is preferably not vibrated, however, vibrating the mixture for a short period of time. The vibrating period of time is commonly from about 1 to about 20 minutes, more commonly from about 2 to about 12 minutes, even more commonly from about 3 to bout 10 minutes, or more commonly from about 5 to about 8 minutes. The frequency of the vibration is commonly from about 10 to about 150 Hz, more commonly form about 20 to about 120 Hz, even more commonly from about 30 to about 100 Hz, or yet even more commonly from about 40 to about 90 Hz. This vibration is typically applied for no more than about 5 minutes, more typically for no more than about 3 minutes, yet even more typically for no more than about 2 minutes, still yet even more typically no more than about 1 minute, or yet still more typically no more than about 30 seconds.

In some embodiments, a release agent is applied to inside surface of the mold. The release agent is preferably selected from the group consisting essentially of silicone oil, aluminum foil, Teflon™ or any other commercially available release agent that has little or no adsorption by material comprises the filter block.

The mixture is preferably heated a temperature commonly from about 100 degrees Celsius to about 600 degrees Celsius, more commonly from about 200 degrees Celsius to about 500 degrees Celsius, or even more commonly form about 200 to about 300 degrees Celsius. The mold is maintained at the temperature for preferably more than about 1 hour, more preferably about 1.5 hour, even more preferably for about 2 hours, yet even more preferably for more than about 2.5 hours, or still yet even more preferably for more than about 4 hours. The mold is prefer ably heated in an oven using a non-convection, forced air or forced inert-gas convection oven.

Preferably, the mold comprises or any material capable of withstanding temperatures exceeding about 600 degrees Celsius, more preferably capable of withstanding temperatures exceeding 400 degrees Celsius. In some embodiments, the mold comprises one of aluminum, cast iron, or steel.

After the heating step, the mold is optionally cooled, and the filter block is released from the mold.

The process may optionally include compressing the mold before the heating step. When the compression is applied, the pressure is preferably not more than 12 Kg/cm², more preferably from about 4 to about 8 kg/cm². The pressure is preferably applied using either a hydraulic press or a pneumatic press, more preferably a hydraulic press.

Some embodiments include a process for making a filter block comprising activated carbon particles and rare earth particles having the relatively low level of variation in rare earth content throughout the filter block.

The process can comprise in some embodiments:

contacting activated carbon particles with a rare earth-containing slurry to form an aqueous mixture;

mixing the aqueous mixture with a binder to form a binder mixture;

adding said binder mixture to a mold;

heating said binder mixture to form a filter block; and,

removing the filter block from the mold.

The rare earth-containing slurry comprises a water-insoluble rare earth-containing composition. Preferably, the water-insoluble rare earth-containing composition comprises cerium oxide, CeO₂.

The rare earth content of the rare earth-containing slurry is commonly at no more than about 1 wt %, more commonly no more than about 5 wt %, even more commonly no more than about 10 wt %, yet even more commonly no more than about 15 wt %, still yet even more commonly no more than about 20 wt %, still yet even more commonly no more than about 25 wt %, still yet even more commonly no more than about 30 wt %, still yet even more commonly no more than about 35 wt %, still yet even more commonly no more than about 40 wt %, still yet even more commonly no more than about 45 wt %, still yet even more commonly no more than about 50 wt %, still yet even more commonly no more than about 55 wt %, still yet even more commonly no more than about 60 wt %, still yet even more commonly no more than about 65 wt %, still yet even more commonly no more than about 70 wt %, still yet even more commonly no more than about 75 wt %, still yet even more commonly no more than about 80 wt %, still yet even more commonly no more than about 85 wt %, or still yet even more commonly no more than about 90 wt %.

In some embodiments, the binder mixture in the mould is compressed before heating the mold.

Preferably, the binder has a melt flow index of no more than about 5 g/10 minutes.

In some embodiments, the activated carbon particle weight to the binder weight ratio is from about 2:1 to about 10:1, more preferably from about 2:1 and 8:1. In other embodiments, the total of the activated carbon particle and water-insoluble rare earth to the binder weight is from about 2:1 to about 10:1, more preferably from about 2:1 and 8:1.

The activated carbon particles are mixed with the rare earth-containing slurry to form an aqueous mixture. The mixing is preferably done in vessels which include an agitator, mixer with dulled impeller blades, ribbon blender, rotary mixer or any other low shear mixer that does not significantly alter the particle size distribution of one or both of the activated carbon particles and the water-insoluble rare earth-containing composition. Preferably, the mixing is carried out to for a substantially uniform mixture of the activated carbon particles and the water-insoluble rare earth-containing composition. The binder is then added to the aqueous mixture and further mixed to obtain a binder mixture. The mixing is preferably carried out for at least about 5 minutes, more preferably from about 5 to about 10 minutes. The binder mixture is optionally vibrated for a short period, as for example from about 3 to about 10 minutes to compact the binder mixture before molding. The vibratory compaction is preferably carried out in a vibrator having frequency from about 30 to about 100 Hz. The vibratory process is preferably carried out for a period of at least about one minute, more preferably from about 3 to about 10 minutes. The binder mixture, whether or not compacted by vibration, is placed in a mold of pre-selected size and shape and is compressed by applying pressure. Preferably, the pressure is more than about 20 kg/cm², preferably from about 3 to about 15 kg/cm² and most preferably from about 4 to about 10 kg/cm². The pressure is preferably applied using either a hydraulic press or a pneumatic press, more preferably a hydraulic press. The mold is preferably made of a material capable of withstanding temperatures exceeding 400° C. More preferably, the mold comprises one of aluminium, cast iron, or steel. The binder mixture is heated to a temperature of from about 150 to 350 degrees Celsius, preferably from about 200 to 300 degrees Celsius. The temperature, the binder mixture is heated to, is maintained for more than about 60 minutes, preferably from about 90 to about 300 minutes to form the filter block. The heating process is preferably conducted in a non-convection, forced air or forced inert-gas convection oven. After the heating process, the mold is cooled. The filter block is removed from the mold. The filter block may be removed before or after the mold is cooled.

Preferably, a release agent applied to the inside surface of the mold. The release agent is preferably selected from the group consisting essentially of silicone oil, aluminum foil, Teflon™ or any other release agent that has little, if any absorption or absorption filter block.

Some embodiments include a block filter comprising a binder having a melt flow index from commonly about 1.2 g/10 min to about 10 g/10 min, more commonly a melt flow index from about 1.3 g/10 min to about 10 g/10 min, even more commonly a melt flow index from about 1.4 g/10 min to about 5 g/10 min, or yet even more commonly a melt flow index from about 1.4 g/10 min to about 3 g/10 min; a polydispersity M_{w}/Mₙ typically from about 3 to about 30, or more typically a polydispersity M_{w}/Mₙ from about 4 to about 8; and a bulk density commonly from about 0.05 g/cm³ to about 0.5 g/cm³, more commonly a bulk density from about 0.1 g/cm³ to about 0.5 g/cm³, even more commonly a bulk density from about 0.13 g/cm³ to about 0.3 g/cm³, or yet even more commonly a bulk density from about 0.15 g/cm³ to about 0.28 g/cm³. In some formulations, the binder is provided in the form of binder particles commonly having an average and/or mean particle size from about 1 μm to about 500 μm, more commonly an average and/or mean particle size from about 5 μm to about 300 μm, more commonly an average and/or mean particle size from about 60 μm to about 200 μm, yet more commonly an average and/or mean particle size from about 80 μm to about 180 μm, still yet more commonly an average and/or mean particle size from about 80 μm to about 160 μm or yet still even more commonly an average and/or mean particle size from 100 μm to about 140 μm.

Preferably, the binder comprises organic, thermoplastic materials. The binder is preferably provided as a powder of comprising one or both of high and ultrahigh molecular weight thermoplastic, such as polyethylene. These thermoplastics are, on heating, capable of binding in a viscous transition phase the activated carbon and rare earth particles. Furthermore, the binder is believed to be able to form a porous structure with the activated carbon and rare earth particles when sintered. In some formulations, the binder comprises a polyethylene homopolymer and/or polyethylene copolymer.

Preferably, the block filter has high strength and low binder content. Furthermore, preferably little, if any, of one or both of the activated carbon particles and the rare earth particles are coated with the binder.

The filter block preferably has a high activated carbon and/or rare earth particle adsorbency. Moreover, the filter black has a permeable porous structure. The permeable porous structure provides for filter blocks having a high fluid flow rate.

After sintering, a block of activated carbon having a high adsorbency and good mechanical strength is obtained. A high filtrate flow is made possible by the high porosity.

Some embodiments include a process for making a filter block comprising the steps of: mixing, in a dry state, activated carbon particles, rare earth particles, and a binder to for a dry mixture; charging the dry mixture to a mold; applying heat, in the substantial absence of air, to the dry mixture in the mold to form a filter block; and after removing, after the heating step, removing the filter block from the mold. The binder preferably comprises a polymeric binder, more preferably a thermoplastic polymer. Even more preferably, the binder comprises a high molecular weight polyethylene. During the applying heat step, suffice heat is applied to dry mixture to substantially melt the binder. Preferably, suffice heat to the dry mixture to raise the temperature of the dry mixture to a temperature of at least the melting temperature of the binder, preferably to temperature more than about melting temperature of the binder. At these temperatures, the binder melts slowly.

Preferably, the filter block commonly comprise from about 1 wt % to about 50 wt % of the binder, more commonly from about 5 wt % to about 40 wt % of the binder, even more commonly from about 8 wt % to about 30 wt % of the binder, yet even more commonly from about 10 wt % to about 25 wt % of the binder, or still yet even more commonly from about 12 wt % to about 20 wt % of the binder; and typically from about 50 wt % to about 99% of a mixture of activated carbon and rare earth particles, more typically from about 60 wt % to about 95 wt % of a mixture of activated carbon and rare earth particles, even more typically from about 70 wt % to about 92 wt % of a mixture of activated carbon and rare earth particles, yet even more typically from about 75 wt % to about 90 wt % of a mixture of activated carbon and rare earth particles, or even more typically from about 88 wt % to about 80 wt % of a mixture of activated carbon and rare earth particles. In some embodiments, the activated carbon particle mass to rare earth particle mass ratio is one of from about 0.1:10 to about 10:0.1; from about 1:5 to about 5:1; from about 1:3 to about 3:1, about 1:2 to about 2:1; or about 1:1. More preferably, the binder comprises a polyethylene homopolymer and/or copolymer.

Some embodiments include a method for making filter block comprising the steps of: forming a mixture comprising activated carbon particles, rare earth particles, binder particles and a liquid; charging the mixture to a mold; applying pressure to and passing hot stream of gas through the mixture to form a filter block; removing the filter block from the mold.

Preferably, the mixture is a homogeneous free-flowing mixture. According to some embodiments, the mixture is formed any suitable mixing apparatus, as described herein. Preferably, the mixture comprises a substantially homogeneous distribution of the activated carbon particles, rare earth particles, and binder particles. More preferably, the mixture has a viscosity that assures easily poured and is substantially self-leveling, that is when charged to the mold the mixture evenly distributes across the entire cross-section of the mold without an additional processing step.

Preferably, the liquid has an evaporation temperature no greater than the melting temperature of the binder. More preferably the liquid is water.

The method further includes adding water to one or more of the activated carbon, rare earth particles or binder particles prior to forming the mixture. Preferably, the water is added to activated carbon particles. The mixing mass ratio of activated carbon to water is typically 1:5, more typically the mixing ratio of activated carbon to water is 1:3, even more typically the mixing ratio of activated carbon to water is 1:2.5, yet even more typically the mixing ratio of activated carbon to water is 1:2, still even more typically the mixing ratio of activated carbon to water is 1:1.5, still yet even more typically the mixing ratio of activated carbon to water is 1:1, still yet even more typically the mixing ratio of activated carbon to water is 1.5:1, still yet even more typically the mixing ratio of activated carbon to water is 2:1, still yet even more typically the mixing ratio of activated carbon to water is 2.5:1, still yet even more typically the mixing ratio of activated carbon to water is 3:1, or yet still even more typically the mixing ratio of activated carbon to water is 5:1.

The pressure applied is preferably from about 5 to about 30 bar/cm². The pressure is applied to the mixture while the mixture is contained in the mold. Air is passed through the mixture, preferably while the mixture is contained in the mold. More preferably, the air is passed the mixture while the mixture is contained in the mold and the pressure is being applied. The air is commonly at a temperature from about 100 to about 300 degree Celsius, more commonly at a temperature from about 100 to about 250 degrees Celsius, even more commonly at a temperature from about 100 to about 225 degrees Celsius, yet even more commonly at a temperature from about 125 to about 200 degrees Celsius, yet still even more commonly at a temperature from about 125 to about 175 degrees Celsius, or still yet even more commonly at a temperature from about 125 to about 165 degrees Celsius. Preferably, the temperature is substantially at or above the melt temperature of the binder. The binder melts and/or becomes tacky at or above the melt temperature of the binder. It is believed that the melted or tacky binder forms bridges between the binder and the activated carbon and rare earth particles. The binder preferably comprises polyethylene particles.

The method may further include, after the passing the hot stream of gas through the mixture, cooling the formed filter mold. Preferably, the cooling step is after passing the hot stream of gas through the mixture and before the removing of the filter block from the mold.

Preferably, the hot stream of gas is hot air. The hot stream of gas is applied to the mixture through the compression mold during pressing. This hot stream of gas passes through the mixture at a temperature that is higher than the evaporation temperature of the liquid.

The rare earth composition can be used to remove, deactivate or detoxify chemical and biological contaminants in a fluid by contacting the fluid with the rare earth composition. Those familiar with the art of fluid treatment will understand that the composition, physical dimensions and shape of the rare earth composition may be manipulated for different applications and that variations in these variables can alter flow rates, back-pressure, and the activity of the rare earth composition for treating certain contaminants. As a result, the size, form and shape of the rare earth composition can vary considerably depending on the intended method of use.

The rare earth composition can be formed though one or more of calcining, sintering, compaction, and combinations thereof. The formed rare earth composition can be combined with one or more of a binder, a substrate, an adhesive, and/or other techniques known in the art. It should be noted that neither a binder nor a substrate is required in order to form the rare earth composition although such components may be desired depending on the intended application. In embodiments where the fluid is to flow through a bed comprising the rare earth composition, the rare earth composition can incorporate with a substrate and/or a polymer binder so that the resulting rare earth composition has one or both high surface area and a relatively open structure. A rare earth composition having both a high surface area and a relatively open structure maintains elevated activity for treating contaminants in the fluid without imposing a substantial pressure drop on fluid flow. In embodiments where it is desired that the rare earth composition have higher surface areas, sintering is a more preferred technique for forming the rare earth composition.

Optional components that are suitable for use in the filter block can include decontamination agents, biocidal agents, adsorbents, flow aids, binders, substrates, and the like. Such optional components may be included in the rare earth composition depending on the intended utility and/or the desired characteristics of the composition.

Other optional components can include various inorganic agents including ion-exchange materials such as synthetic ion exchange resins, activated carbons, zeolites (synthetic or naturally occurring), minerals and clays such as bentonite, smectite, kaolin, dolomite, montmorillinite and their derivatives, metal silicate materials and minerals such as of the phosphate and oxide classes. In particular, mineral compositions containing high concentrations of calcium phosphates, aluminum silicates, iron oxides and/or manganese oxides with lower concentrations of calcium carbonates and calcium sulfates may be suitable. These materials may be calcined and processed by a number of methods to yield mixtures of varying compositions and properties.

A binder may optionally be included for forming an aggregate rare earth composition having desired size, structure, density, porosity and fluid properties. In addition to, or as an alternative to the use of a binder, a substrate may be included for providing support to the aggregate rare earth composition. Suitable binder and substrate materials can include any material that will bind and/or support the rare earth-containing compound wider conditions of use. Such materials will generally be included in the aggregate composition in amounts ranging from about 0 wt % to about 98 wt %, 1-95 based upon the total weight of the composition. Suitable materials can include organic and inorganic materials such as natural and synthetic polymers, ceramics, metals, carbons, minerals, and clays. One skilled in the art will recognize that the selection of a binder or substrate material will depend on such factors as the components to be aggregated, their properties and binding characteristics, desired characteristics of the final aggregate composition and its method of use among others.

Other optional components of the rare earth composition can include additives, such as particle surface modification additives, coupling agents, plasticizers, fillers, expanding agents, fibers, antistatic agents, initiators, suspending agents, photosensitizers, lubricants, wetting agents, surfactants, pigments, dyes, UV stabilizers, and suspending agents. The amounts of these materials are selected to provide the properties desired. Such additives may be incorporated into a binder or substrate material, applied as a separate coating, held within the structure of the rare earth composition, or combinations of the above.

In some embodiments, the filter block optionally includes one or more flow aids. The flow aids are used in part to improve the fluid dynamics of a fluid over or through the filter block, to prevent the migration and/or movement of fines, and in some cases to hold the filter block. Suitable flow aids can include both organic and inorganic materials. Inorganic flow aids can include ferric sulfate, ferric chloride, ferrous sulfate, aluminum sulfate, sodium aluminate, polyaluminum chloride, aluminum trichloride, silicas, diatomaceous earth and the like. Organic flow aids can include organic flocculents known in the art such as polyacrylamides (cationic, nonionic, and anionic), EPI-DMA's (epichlorohydrin-dimethylamines), DADMAC's (polydiallydimethyl-ammonium chlorides), dicyandiamide/formaldehyde polymers, dicyandiamide/amine polymers, natural guar, etc. When present, the flow aid can be incorporated during the formation of the filter block, or after the formation of the filter block. When present, flow aids are generally used in low concentrations of less than about 20 wt %, in some cases less than 15 wt %, in other cases less than 10 wt %, and in still other cases less than about 8 wt % by weight of the filter block.

In accordance with some embodiments, the filter block is configured optionally within a water treatment system with one or more:

a) a first treatment element A;

b) an ion-exchange filter; and

c) a second treatment element A.

The filter block can be positioned upstream or downstream from the first treatment element A. The filter block can be positioned upstream or downstream from the ion-exchange filter. The filter block can be positioned upstream or downstream from the second treatment element A. The first treatment element A can be positioned upstream or downstream of ion-exchange filter. The first treatment element A can be positioned upstream or downstream of second treatment element A. The ion-exchange filter can be positioned upstream or downstream of the second treatment element A.

The first treatment element A can comprise one of a membrane filter, an oxidant, a reducant, a precipitant, a solvent exchange process, or copper/silver ionization treatment element for removing a contaminant. The second treatment element A can comprise one of a membrane filter, an oxidant, a reducant, a precipitant, a solvent exchange process, or copper/silver ionization treatment element for removing a contaminant. Typically, the first and second treatment elements differ. However, in some embodiments the first and second treatment elements can be the same.

Preferably, the filter block removes one or more contaminants substantially passed by one or more of the upstream elements (that is, any ion-exchange filter, firs treatment element A or second treatment element A) upstream of the filter block. In some embodiments, the upstream treatment chemically transforms an undesirable material contained in the fluid being treated into a contaminant that can be removed by the downstream filter block.

In some embodiments, the filter block substantially removes any contaminants that could interfere with one or more of the downstream elements (that is, any ion-exchange filter, firs treatment element A or second treatment element A downstream of the filter block).

In some embodiments, the filter block comprises a substrate, and a rare earth composition disposed on the substrate and/or restrained by and/or contained within in the substrate. Preferably, the rare earth composition is disposed on the substrate. More preferably, the rare earth, rare earth-containing composition and/or rare earth particles are contained within, that is dispersed within, the substrate. In yet another embodiment, the rare earth, rare earth-containing composition and/or rare earth particles are restrained by the substrate. For example, the rare earth, rare earth-containing composition and/or rare earth particles can be restrained when positioned between two substantially similar substrates.

The substrate can comprise one or more materials selected from the group consisting of polymers, ceramics, metals, fibers, textiles, carbons, minerals, and clays. More specifically, when the substrate comprises a polymer the polymer can comprise one or more materials selected from the group consisting of thermosetting polymers, thermoplastic polymers, elastomeric polymers, natural and synthetic polymers, cellulosic polymers, woven and non-woven textile material, natural and synthetic fibers and fibrous materials, and glasses. The substrate can also comprise an aggregate of one or more of fibers and particulates. The substrate can be in the form of one or more of a monolith, fabric and mat. In one embodiment, the aggregate composition comprises aggregated particulates adhered to and/or embedded in an outer surface of the substrate.

In some embodiments, the filter block comprises a rare earth composition substantially encased and/or restrained within one or more void volumes defined by at least one substrate. The first and second substrates may substantially encase and restrain the rare earth, rare earth-containing composition and/or rare earth particles within a void volume or a plurality of void volumes. The substrate has one or both of sufficient porosity and permeability to transmit the fluid such that the fluid contacts the rare earth, rare earth-containing composition and/or rare earth particles encased and/or restrained within the one or more void volumes. Substrates having greater porosity and/or permeability allow for greater contact of the rare earth, rare earth-containing composition and/or rare earth particles with the fluid than substrates having lesser porosity and/or permeability.

In some embodiments include a process comprising contacting a fluid containing one or more chemical and active biological contaminant with the filter block. Preferably, the filter filter block contains a rare earth, rare earth-containing composition and/or rare earth particles. The rare earth, rare earth-containing composition and/or rare earth particles may comprise a sintered rare earth composition. Contact of the fluid with the rare earth, rare earth-containing composition and/or rare earth particles removes, deactivates and/or detoxifies one or more contaminants contained in the water to yield purified water and a contaminant laden rare earth, rare earth-containing composition and/or rare earth particle. The purified water is substantially depleted of the at least one or more of the contaminants contained in the water. In one embodiment, the fluid contacts the filter block at a temperature of less than about 200° C.

The rare earth, rare earth-containing composition and/or rare earth particles can be used in fixed or fluidized beds or reactors, stirred reactors or tanks, distributed in particulate filters, encapsulated or enclosed within membranes, mesh, screens, filters or other fluid permeable structures, deposited on substrates, and may further be formed into and/or restrained by one of a sheet, film, mat, a netting, a non-woven textile, a woven textile monolith or combinations thereof for various applications. In addition, the rare earth, rare earth-containing composition and/or rare earth particles can be incorporated into or coated onto a substrate, such as, but not limited to, a filter substrate. Suitable substrates can be formed from the described binder and substrate materials such as sintered ceramics, sintered metals, microporous carbon, glass fibers and beads, natural fibers or polymers, such as cellulosic fibers such as cotton, paper and wood, or combinations thereof. The structure of the substrate will vary depending upon the application but can include woven and non-wovens in the form of a porous membrane, netting or containment configuration, filter or other fluid permeable structure. Substrates can also include porous and permeable solids having a desired shape and physical dimensions. Such substrates can include mesh, screens, tubes, honeycombed structures, monoliths and blocks of various shapes including cylinders and toroids.

In other embodiments, the filter block can be positioned in a container and a fluid caused to flow through and or contact the filter block. The fluid can be pumped or drawn through and/or in contact with the filter block, with or without agitation or mixing. Various fittings, connections, pumps, valves, manifolds and the like can be used to control the flow of the fluid through the filter block in a given container.

The fluid contacts the filter block at a temperature of less than about 200° C. In some cases, the fluid contacts the filter block at a temperature less than about 150° C., in other cases, at a temperature less than about 120° C., and in still other cases less than about but 100° C. In some embodiments, the fluid contact the filter block at or about room temperature. The filter block is effective at removing, deactivating, and detoxifying chemical and biological contaminants at room temperatures. The pressure at which the fluid contacts the filter block can vary considerably depending on the application, but again, the rare earth composition can effectively treat a fluid at ambient pressures.

After contacting the fluid, the filter block contains one or more of the contaminant s contained in the water. Furthermore, the one or more chemical and biological contaminants are substantially removed and/or detoxified by the filter block. In some instances, it may be advantageous to sterilize and/or further process the filter block before re-use or disposal. Moreover, it may be desirable to sterilize and/or further process the filter block prior to initial use to remove any biological contaminants that may be present before use. Sterilization or further processing can include thermal processes wherein the filter block kis exposed to elevated temperatures or pressures or both, radiation sterilization wherein the rare earth composition is subjected to elevated radiation levels using ultraviolet, infrared, microwave, and/or ionizing radiation, as well as chemical sterilization wherein the rare earth composition is exposed to elevated levels of oxidants, reductants or other chemical species. More specifically, chemical species that may be used in chemical sterilization and/or further processing can include halogens, reactive oxygen species, formaldehyde, surfactants, metals and fluids such as ethylene oxide, methyl bromide, beta-propiolactone, and propylene oxide. Combinations of these processes can also be used and it should further be recognized that such sterilization and/or further processing may be used on an intermittent or continuous basis while the filter block is in use.

The process can optionally include the step of sensing the fluid after it has contacted the filter block and is depleted of contaminants so as to determine or calculate when it is appropriate to replace the filter block. Sensing of the fluid can be achieved through conventional means such as tagging and detecting the contaminants in the fluid, measuring flow rates, temperatures, pressures, sensing for the presence of fines, and sampling and conducting arrays.

In another embodiment, the filter block comprises a substrate and a rare earth, rare earth-containing composition and/or rare earth particles disposed on and/or contained by the substrate.

The substrate can comprise any of the binder and substrate materials described herein, including one or more materials selected from the group consisting of polymers, ceramics, metals, carbons, minerals, textiles, and clays. More specifically, the substrate can comprises one or more polymer materials selected from the group consisting of thermosetting polymers, thermoplastic polymers, elastomeric polymers, cellulosic polymers, natural polymers, and glasses. The substrate can also comprise natural and synthetic fibers, particulates, and mixtures and aggregates of the same. Specific non-limiting examples of the substrate include polyolefins such as polyethylene, cellulose acetate, acrylonitrile-butadiene-styrene, PTFE, cellulosic fibers, and fiberglass. The substrate can be processed into a variety of sizes and shapes including but not limited to a monolith, woven and non-woven fabric, mat or netting. In one embodiment, the rare earth composition can comprise aggregated particulates adhered to or embedded in an outer surface of the substrate. In one configuration, the substrate comprises a filter.

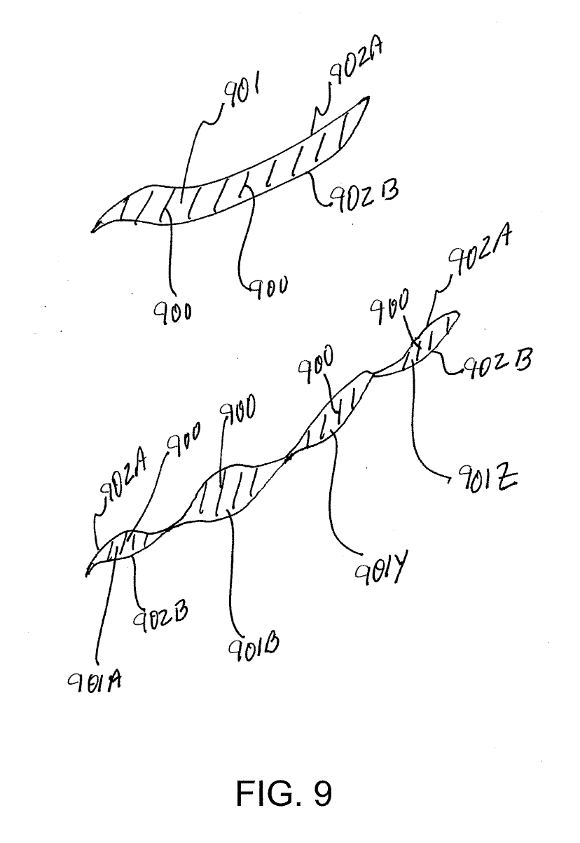

FIG. 9 depicts another embodiment of the invention comprising a rare earth composition 900 substantially encased and/or restrained within one or more void volumes 901 defined by at least one substrate 902. In one embodiment, first 902A and second 902B substrates substantially encase and restrain the rare earth composition 900 within a void volume 901 or a plurality of void volumes 901A, 901 B, . . . , 901Y, 901Z. In one configuration, the plurality of void volumes 901A, 901 B, . . . , 901Y, 901Z can be formed by operatively joining first 902A and second 902B substrates. The substrate 902 has one or both of sufficient porosity and permeability to transmit the fluid such that the fluid contacts the rare earth composition 900 encased and/or restrained within the one or more void volumes 901A, 901 B, . . . , 901Y, 901Z. The first 902A and second 902B substrates can be joined by one or more of stitching, adhesive joining, welding, fusion bonding, weaving, mechanical joining, chemical bonding and/or fusing, or combinations thereof. Substrates 902 having greater porosity and/or permeability allow for greater contact of the rare earth composition 900 with the fluid than substrates with lesser porosity and/or permeability.

The ion-exchange filter may comprise any ion-exchange resin. One such suitable ion-exchange resins are described in U.S. Pat. No. 5,067,912 to Belz et al., the entire contents of which is incorporated herein by this reference.

In some embodiments, the rare earth, rare earth-containing composition and/or rare earth particles can be retained by the substrate at least in part by forming one or more chemical bonds with the substrate, the one or more chemical bonds can covalent and/or ionic chemical bonds. The rare earth, rare earth-containing composition and/or rare earth particles can be directly chemically bond to the substrate and/or can be indirectly chemically bonded to the substrate. Examples of indirect chemically bonding of the rare earth, rare earth-containing composition and/or rare earth particles to the substrate is when the rare earth, rare earth-containing composition and/or rare earth particles is chemically bonded to the substrate through a coupling agent or an adhesion promoter (as discussed herein below).

More specifically, the rare earth, rare earth-containing composition and/or rare earth particles can react with the substrate to be chemically retained by the substrate. The rare earth, rare earth-containing composition and/or rare earth particles can react with chemical entities on the substrate to be retained by the substrate. That is, the reaction of the rare earth, rare earth-containing composition and/or rare earth particles with the chemical entities on the substrate chemically bonds the rare earth, rare earth-containing composition and/or rare earth particles to the substrate.

The chemical bond between the rare earth, rare earth-containing composition and/or rare earth particles and the substrate can be a covalent bond, an ionic bond, and a combination thereof. The chemical reaction can be a solution-enabled or a vapor-enabled reaction. That is, the substrate (and/or the reactive entities on the substrate) is/are reacted with rare earth, rare earth-containing composition and/or rare earth particles contained within a fluid (such as, the rare earth, rare earth-containing composition and/or rare earth particles contained within a solution, a slurry, or a vapor phase).

Non-limiting examples of reactive entities and/or substrates are the oxygen-containing and/or ionically charged sites on clays, alumina, gamma-alumina, activated alumina, acidified alumina, metal oxides, crystalline aluminosilicates, amorphous silica-alumina, amorphous silica (such as, but not limited to amorphous silica beads), ion exchange resins, ferric sulfate, and porous ceramics.

In another example, the rare earth, rare earth-containing composition and/or rare earth particles can be reacted with a radical entity on the substrate, such as, a radical entity formed on a substrate by a surface modification process. The radical entity can be any radical entity capable of reacting with a rare earth, rare earth-containing composition and/or rare earth particles, such as, a free radical entity, an ionic entity, an electronegative entity, and an electropositive entity. In some instances, the radical entity can also include nucleophilic and electrophilic entities. Exemplary radical entities are hydroxyls, carboxylates, amines, amides, phosphates, oxyanions, oxides, oxygen-containing functional groups, nitrogen-containing functional groups and sulfur-containing functional groups, phosphites, phosphates, sulfites, sulfates, nitrites, nitrates and chemical derivates thereof. The radical entity can be formed by any suitable surface modification process, including flame treatment, corona treatment, radiation treatment, an oxidative process, a derivatization process (such as, chemically attaching a linking entity (that is, an adhesion promoter or cross-linkable adhesion promoter) to the substrate), ion implanting and/or plating treatment, metal and/or metal-containing composition implanting and/or plating (such as, a Ti pretreatment of a glass substrate) treatment, and ionizing treatment. The rare earth, rare earth-containing composition and/or rare earth particles is contacted and reacted with the radical entity contained on the substrate to retain the rare earth, rare earth-containing composition and/or rare earth particles substrate. In another embodiment, after contacting and reaction the rare earth, rare earth-containing composition and/or rare earth particles with the radical entity, (an) additional chemical reaction(s), can be conducted. The additional chemical reaction can be include cross-linking the adhesion promoter, converting the rare earth, rare earth-containing composition and/or rare earth particles on the substrate to an insoluble rare earth-containing composition, and/or a reaction process to more permanently fix the rare earth-containing composition to the substrate. An example of a possible linker is described in U.S. Pat. No. 6,224,898 to Balogh, the entire contents of which are incorporated herein in their entirety by this reference.

In a mechanical process the rare earth, rare earth-containing composition and/or rare earth particles can be retained by the substrate by a mechanical interlocking and/or encompassing process. That is, one or more of pores, holes, crevices, and/or other irregularities contained on and/or within the substrate can retain the rare earth, rare earth-containing composition and/or rare earth particles on the substrate. Exemplary porous substrates include without limitation zeolites, diatomaceous earth, activated carbon, woven textiles, nonwoven textiles, textile piles, reticulated polymeric materials, anodize aluminum surfaces, etc. In another technique, the substrate is contacted with a rare earth-containing solution and/or dispersion, the rare earth, rare earth-containing composition and/or rare earth particles solution and/or dispersion coats and/or impregnates the substrate to form a coated and/or impregnated substrate. The coated and/or impregnated substrate can be dried, after being contacted with the rare earth, rare earth-containing composition and/or rare earth particles solution and/or dispersion.

Preferred fiber substrates are cellulosic fibers, synthetic polymeric fibers and metal-containing fibers. In one configuration, the polymer comprising the polymeric fibers has one or more glass transition temperatures. The rare earth, rare earth-containing composition and/or rare earth particles in a solid form is contacted with the polymeric fibers at about one of the one or more glass transitions temperatures. The glass transition temperature is the temperature at which amorphous regions of the polymeric material become soft and flexible, that is rubbery and/or tacky. The glass transition temperature and the melting point of the polymeric material digger, the glass transition temperature is a second order transition and a property of the amorphous regions of the polymeric material, while the melting point is a first order transition and a property of the crystalline regions of the polymer. Preferably, the polymeric fiber comprises a polymer having at least about 10 wt % amorphous polymer phase, more preferably at least about 20 wt % amorphous polymer phase, even more preferably at least about 30 wt % amorphous polymer phase, and yet even more preferably at least about 40 wt % amorphous phase. In some configurations, the polymeric fiber comprises a polymer having at least most of the polymer comprises a amorphous phase. In preferred embodiment, the amorphous phase comprises at least about 60 wt % of the polymeric fiber, more preferred the amorphous phase of the polymer comprises at least about 70 wt % of the polymeric fiber, even more the amorphous phase of the polymer comprises at least about 80 wt % of the polymeric fiber, and yet even more preferred the amorphous phase of the polymer comprises at least about 90 wt % of the polymeric fiber.

Non-limiting examples of suitable polymer fibers and their representative glass transition temperatures are: poly(vinyl acetate) typically having a glass transition temperature of about 28° C., poly(ethyleneterephthalate) typically having a glass transition temperature of about 69° C., poly(vinyl alcohol) typically having a glass transition temperature of about 85° C., poly(vinyl chloride) typically having a glass transition temperature of about 81° C., polypropylen (isotatic) typically having a glass transition temperature of about 100° C., and polystyrene typically having a glass transition temperature of about 100° C.

The rare earth, rare earth-containing composition and/or rare earth particles can be retained by the substrate through a diffusion process. More specifically, but briefly, retention by a diffusion process typically involves at least some of the rare earth, rare earth-containing composition and/or rare earth particles to diffuse into the substrate and at least some of substrate to diffuse into the rare earth, rare earth-containing composition and/or rare earth particles substrate. While not wanting to be limited by theory and/or example, the rare earth, rare earth-containing composition and/or rare earth particles can be retained by the substrate when the process includes one or more of sintering, calcinating, alloying, and/or annealing.

In yet another process, the rare earth, rare earth-containing composition and/or rare earth particles can at least in part be retained by the substrate by at least an electrostatic interaction. While not wanting to be limited by theory, the rare earth, rare earth-containing composition and/or rare earth particles and the substrate have differing electronegatives, this difference in electronegatives can give rise to an electrostatic interaction which can elctrostatically retain the rare earth, rare earth-containing composition and/or rare earth particles on the substrate.

In another embodiment, the substrate is activate by one or more of softening, partially melting, tackifying, physically modifying, and chemically modifying the substrate to form an activated substrate.

The rare earth, rare earth-containing composition and/or rare earth particles that is contacted with and subsequently retained by the substrate can be in any form. That is, the rare earth, rare earth-containing composition and/or rare earth particles can be in the form of a solid (such as, in the form of a powder, particles, nanoparticles, and/or sub-micron particles), a solution (such as, rare earth-containing composition dissolved and/or solublized in a liquid), a slurry (such as, dispersion and/or colloid containing the rare earth, rare earth-containing composition and/or rare earth particles), and/or a vapor phase rare earth-containing composition.

In another embodiment, the rare earth, rare earth-containing composition and/or rare earth particle is contacted with the substrate in the form of a solution (such as, rare earth-containing composition dissolved and/or solublized in a liquid) and/or slurry (such as, a liquid dispersion and/or colloid containing the rare earth, rare earth-containing composition and/or rare earth particles). Preferably, the liquid comprising the solution and/or slurry comprises water. In a preferred embodiment, the contacting of the rare earth-contacting solution and/or slurry with the substrate results in at least some, if not most, of the rare earth, rare earth-containing composition and/or rare earth particles contained within the rare earth, rare earth-containing composition and/or rare earth particles solution and/or slurry to be retained by the substrate to form a rare earth-retained substrate. The some, if not most, of the rare earth, rare earth-containing composition and/or rare earth particles is retained by the substrate by at least in part by one or more the process described above.

In some configurations, the rare earth-retained substrate is deliquefied to form a first rare-containing substrate. That is, at least most, if not all, of any liquid retained by substrate from the contacting of the rare earth, rare earth-containing composition and/or rare earth particles solution and/or slurry is removed. The rare earth-retained substrate can be de-liquefied by one or more of dying in air, applying heat, exposing to a reduced pressure environment, exposing to microwaves, and/or exposing to a reduced humidity environment.

In another configuration, the first rare earth-containing substrate is sintered and/or calcinated to form a second rare earth-containing substrate. In yet another configuration, the rare earth-retained substrate is sintered and/or calcinated to form a third rare earth-containing substrate. The second and third rare earth-containing substrates can be the same or differ. The second and/or third rare earth-containing substrates can comprise an insoluble sintered and/or calcinated rare earth-containing composition. The insoluble sintered and/or calcinated rare earth-containing composition can be the same as and/or differ from the rare earth-composition contained with the rare earth, rare earth-containing composition and/or rare earth particles solution and/or slurry. That is, in some instances, the insoluble sintered and/or calcinated rare earth-containing composition can comprise at least some of the rare earth, rare earth-containing composition and/or rare earth particles contained in the rare earth, rare earth-containing composition and/or rare earth particles solution and/or slurry, and, in other instances, substantially lack (or contain none of) the rare earth, rare earth-containing composition and/or rare earth particles contained in the rare earth, rare earth-containing composition and/or rare earth particle solution and/or slurry. The insoluble sintered and/or calcinated rare earth, rare earth-containing composition and/or rare earth particles can be in the form of one or more of particles, nanoparticles, sub-micron particles, agglomerates, nanocrystals, single crystals and/or plural crystals.

In another configuration, one of the rare earth-retained substrate or first rare earth-containing substrate is exposed to an oxidizing environment and/or agent (as described above) to form an oxidized rare earth-containing substrate, preferably the oxidized rare earth-containing substrate comprises an insoluble rare earth-containing composition.

The oxidized earth-containing substrates can comprise an oxidized rare earth-containing composition. The oxidized rare earth-containing composition can be the same as and/or differ from the rare earth-composition contained with the rare earth, rare earth-containing composition and/or rare earth particles solution and/or slurry. That is, in some instances, the oxidized rare earth-containing composition can comprise at least some of the rare earth, rare earth-containing composition and/or rare earth particles contained in the rare earth, rare earth-containing composition and/or rare earth particles solution and/or slurry, and, in other instances, substantially lack (or contain none of) the rare earth, rare earth-containing composition and/or rare earth particles contained in the rare-earth-containing solution and/or slurry. The oxidized rare earth-containing composition can be in the form of one or more of particles, nanoparticles, sub-micron particles, agglomerates, nanocrystals, single crystals and/or plural crystals.

In some configurations, the one of the oxidizing, sintering, or calcinating process substantially destroys and/or removes the substrate to form a self-supporting rare earth-containing network, preferably of an insoluble self-supporting rare earth-containing network. More preferably, the self-supporting rare earth-containing network is in the form of agglomerated rare earth particles, preferably one or more of rare earth-containing nanoparticles, sub-micron particles, nanocrystals, single crystals and/or plural crystals.

More specifically, the self-supporting rare earth-containing network can, in an embodiment of the present invention, be formed by contacting the rare earth, rare earth-containing composition and/or rare earth particles in the form of one of a plurality of rare-containing particles, a rare earth containing solution and/or slurry, or a rare earth containing vapor and depositing the rare earth, rare earth-containing composition and/or rare earth particles within a sacrificial substrate, after which the rare earth, rare earth-containing composition and/or rare earth particles is formed into a self-supporting rare earth-containing aggregate and/or network and the sacrificial substrate is removed. Preferably, one or both of chemical and physical processes can remove the sacrificial substrate. Non-limiting examples of such chemical and physical processes include, without limitation dissolving, combusting, and reactively removing the sacrificial substrate. In some configurations, the forming of the self-supporting rare earth-containing aggregate and/or network and the removing of the sacrificial substrate can be the same process. As for example, the combustive removal of the sacrificial substrate and a calcinating of the deposited rare earth-containing composition to form the self-supported rare earth-containing aggregate can be conducted at the same time as a single process step. The sacrificial substrate includes natural substrates, such as wood, cotton, hemp, and hydrocarbon-based, synthetic substrates, such as polyethylene terephthalate and polypropylene. The rare earth composition may be retained by the substrate by any of the mechanisms discussed above.

In another embodiment, the volume of the substrate contains the rare earth, rare earth-containing composition and/or rare earth particles. The rare earth, rare earth-containing composition and/or rare earth particles is one of heterogeneously or homogeneously distributed throughout the volume of the substrate. In one technique, the rare earth, rare earth-containing composition and/or rare earth particles and the substrate is in the form of an aggregate. One method for forming the aggregate is discussed in U.S. Patent Application Publication No. 2009/0111289, which is incorporated herein its entirety by this reference.

Another method for forming the aggregate is incorporating the rare earth, rare earth-containing composition and/or rare earth particles into the substrate during formation of the substrate. In one example, the rare earth, rare earth-containing composition and/or rare earth particles can be introduced into a polymeric substrate during polymerization, such as during linear step polymerization, non-linear step polymerization, free-radical polymerization, ionic polymerization, cationic polymerization, anionic polymerization, catalytic polymerization (e.g., Ziegler-Natta coordination polymerization), ring-opening polymerization, solid-state polymerization, metathesis polymerization, group transfer polymerization, and other specialized methods of polymerization, co-polymerization (e.g., step copolymerization, chain copolymerization, block copolymerization, etc.), spin melting and other types of polymer (resin) melting, and extruding. In another example, the rare earth, rare earth-containing composition and/or rare earth particles can be introduced into the substrate as an additive. Techniques for introducing additives into polymers are well known in art. Any of the techniques know within the art for incorporating plasticizers, colorants, lubricants, stabilizers, and other additives, during these various steps/operations utilized with the polymer industry are suitable for the introduction of and the retaining of a rare earth-containing composition with a polymeric substrate. In one preferred embodiment, the rare earth, rare earth-containing composition and/or rare earth particles is introduced into the polymeric substrate during extrusion. In a more preferred embodiment, the extruded polymer containing the rare earth, rare earth-containing composition and/or rare earth particles is formed into desirable shapes and/or configurations, such as fibers, films and sheets, by known techniques. Moreover, the extruded fibers can be formed into woven and/or non-woven fabrics and other textile materials. Furthermore, the films, sheets, textile materials and woven and/or non-woven fabrics containing the rare earth, rare earth-containing composition and/or rare earth particles can be formed in fluid filter sheets, films, blankets, cylinders, membranes, laminates, and other forms for removing target materials from fluid streams.

In yet another embodiment, the rare earth, rare earth-containing composition and/or rare earth particles forms a continuous or discontinuous coating on the substrate. Configurations of this embodiment is discussed in U.S. Pat. No. 6,863,825, which is incorporated herein in its entirety by this reference.

In one embodiment, the rare earth, rare earth-containing composition and/or rare earth particles is retained by a substrate comprising one or more fibrous layers. The rare earth, rare earth-containing composition and/or rare earth particles is retained within at least one of the one or more fibrous layers. The one or more fibrous layers can be woven or non-woven textile layers. The one or more fibrous layers can comprise any of substrates described herein in any combination and the rare earth, rare earth-containing composition and/or rare earth particles can be retained the one or more fibrous layers by any process described herein.

For example, the fibrous layers can comprise a cellulosic fibrous substrate, the rare earth, rare earth-containing composition and/or rare earth particles being retained by the cellulosic fibrous substrate. The rare earth, rare earth-containing composition and/or rare earth particles can be uniformly dispersed throughout the fibrous layer and/or be coated on at least one surface of the fibrous layer. In one configuration, the fibrous layer comprises cellulosic fibers and a plurality of rare earth-containing materials. As used herein rare earth-containing materials means any rare earth-containing composition retained by any substrate as described herein. Non-limiting examples of rare earth-containing materials are any rare earth-containing composition in any form (such as, but not limited to particles, nanoparticles, and/or submicron particles) retained any substrate in any form (such as, but not limited to, fibers, nanofibers and/or submicron fibers). Exemplary examples of rare earth-containing material substrates are fibers, nanofibers and/or submicron fibers comprising one of glass, aluminum, organic polymeric materials, and silicon. The fibrous layer can be made by any method known within the art. In one preferred embodiment, the fibrous layer is made by a let-down method. That is, a plurality of cellulosic and a plurality of rare earth-containing materials are dispersed in a liquid (such as, liquid water) and let-down through a porous bed to form a wet fibrous layer. The wet fibrous layer can be dried to form a fibrous layer, such as, a fibrous filter sheet.

In one configuration the rare earth, rare earth-containing composition and/or rare earth particles is retained with a plurality of the one or more fibrous layers. In another configuration, the rare earth, rare earth-containing composition and/or rare earth particles is retained between opposing fibrous layers. For example, the rare earth composition can be sandwiched between opposing fibrous layers, the fibrous layers can be engaged with one another, such as by stitching, adhesives, fusion, bonding, welding, etc. The opposing fibrous layers can be formed from a single fibrous layer folded-over onto itself, or the opposing fibrous layers can be formed from a plurality of layers.

### Example 1

This Example describes an agglomeration process using cerium dioxide and an emulsion comprising Aquatec Kynar-acrylic polymer and a carbodiimide cross-linker. To a 250 mL cup containing 49 mL of distilled water, 4.57 g of a 47 wt % Aquatec Kynar-acrylic aqueous solution and 1.34 g of a 40 wt % carbodiimide aqueous solution were added with stirring to form an acrylic/carbodiimide emulsion. To the acrylic/carbodimmide emulsion 134.13 g of particulate cerium dioxide (CeO₂) was added to form a particulate mixture. The 134.13 g of particulate CeO₂ was added in two increments, the first increment was about 100 g and second increment was about 34.13 g. The cerium dioxide particulates had a particle size from about 30 to about 50 microns. The particulate mixture was transferred to a Keyence hybrid mixer and mixed twice to produce a paste of wet agglomerated particles. Each mixing time period was about 30 seconds. The paste was transferred to a basket extruder equipped with a 0.6 mm screen and extruded through the screen to form strands. The strands were extrudated into a circulating hot air flow having a temperature of about 60 to about 70 degrees Celsius. The extruded strands were collected and dried for about two hours in an oven at a temperature of about 60 degrees Celsius. After oven drying, the extruded strands were cured at a temperature of about 120 degrees Celsius for about two hours. The cured strands were broken into shorter strands. The shorter strands were sieved through a stack of differing sized screens. The screen sizes ranged from about 106 to about 850 μm. Differing size fractions of the shorter strands were collected by each of the differing sized screens. Each of the differing size fractions were collected and weighed. The shorter strands comprised agglomerated cerium dioxide, more specifically the shorter strands comprised cerium dioxide agglomerated with Aquatec Kynar-acrylic polymer crosslinked with carbodiimide.

### Example 2

Cerium dioxide (CeO₂) can effectively remove arsenic from arsenic-containing waters. More particularly, arsenic can be removed from arsenic-containing waters by a filter bed of particulate cerium dioxide. However, particulate cerium dioxide can contain fines. The fines can create a significant pressure drop when the filter bed is challenged at a high flow rate. In this example, a cerium dioxide filter bed was made with the micron particulate CeO₂ (particle size from about 30 to about 50 microns) used to form the shorter strands. When the filter bed was challenged at about 0.5 bed volume per minute flow rate, a pressure drop of about 17 psi was generated. However, a much smaller pressure drop was generated when agglomerated cerium dioxide was challenged under similar flow-rate conditions. For example, a pressure drop of less than about 1 psi was generated when a bed comprising from about 425 to about 600 micron agglomerated material of Example 1.

### Example 3

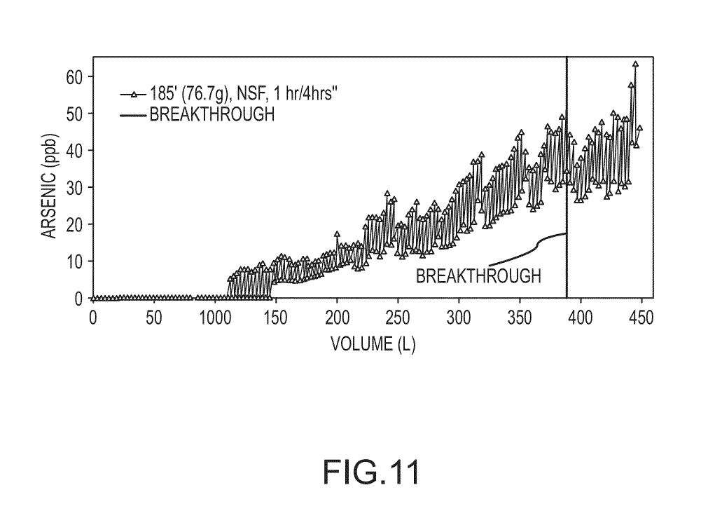

This Example shows that the agglomeration of cerium dioxide does not substantially impair the ability of cerium dioxide to effectively remove arsenic from arsenic-containing waters. About 76 grams of the agglomerated media of Example 1 was formed into a 63 cm³ filter bed. An arsenic (V)-containing water having about 300 ppb of arsenic was treated with the 63 cm³ agglomerated media filter bed. About 388 L of the arsenic (V)-containing water was treated before the breakthrough limit of 50 ppb arsenic (see FIG. 11).

### Example 4

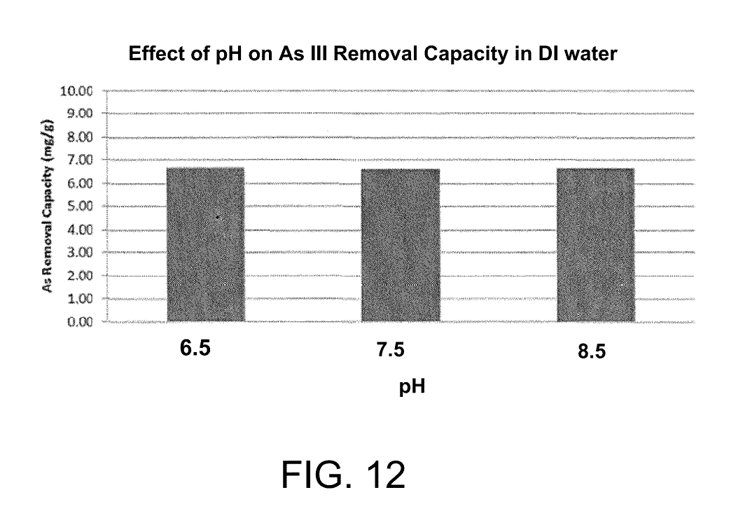

In this Example, the efficacy of agglomerated cerium dioxide to remove arsenic from an arsenic-containing solution was determined. The efficacy testing was conducted at an exposure rate of about 0.67 bed volumes per minute. The arsenic removal capacity was derived from removal isotherms. The removal isotherms were determined with 20 mg samples of the agglomerated cerium dioxide exposed for about 24 hours to 0.5 L of a 500 ppb arsenic (III)-containing deionized water solution (see Table 1 and FIG. 12). The effect of pH on the arsenic removal isotherms was determined for arsenic-containing solutions having pH values of pH 6.5, 7.5 and 8.5 The arsenic (III)-containing solutions were buffered to their respective pH values with 0.125 mMol 4-(2-hydroxyethyl)-1-piperazineethanesulfonic acid (HEPES). An analysis of the arsenic (III)-containing solutions found significant amounts of arsenic (V) in the solutions during the testing period. The isotherm measurements showed insignificant variation in arsenic (III) removal by the agglomerated cerium dioxide over the pH 6.5 to pH 8.5 range tested.

TABLE 1

| | | Initial | Vol | | Mass | Final | Removal |
|---|---|---|---|---|---|---|---|
| | | [As] | Tested | Test Time | Media | [As] | Capacity |
| Media | pH | (ppb) | (L) | (hr) | (g) | (ppb) | (mg/g) |
| Agglomer- | 6.5 | 530 | 0.5 | 24 | 0.0204 | 257 | 6.69 |
| ated Ceria | | | | | | | |
| Agglomer- | 7.5 | 530 | 0.5 | 24 | 0.0213 | 248 | 6.62 |
| ated Ceria | | | | | | | |
| Agglomer- | 8.5 | 530 | 0.5 | 24 | 0.0202 | 262 | 6.65 |
| ated Ceria | | | | | | | |

24 hour isotherms, 20 mg of agglomerated ceria exposed to 0.5 L of 500 ppb As(III)

### Example 5

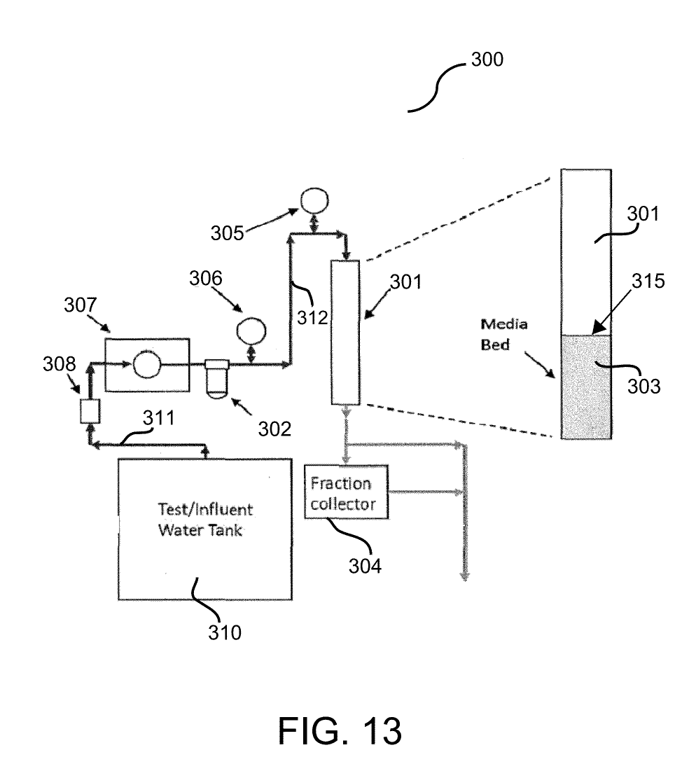

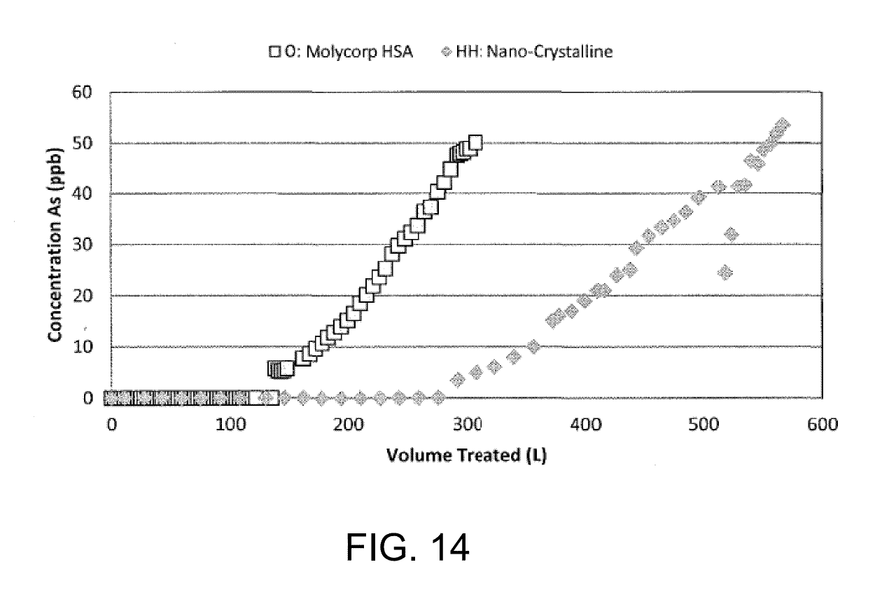

FIG. 13 depicts column set-up 300 used in this example to determine pressure drop in a filter bed of agglomerated cerium dioxide. Column 301 was packed with filter bed media 303. In this particular example, the filter bed media 303 was agglomerated cerium dioxide. Fluid 310 is charged to the column 301 through column in-put line 312 and discharged through column out-put line 313. Pump 307 is interconnected to tank line 311 and column in-put line 312, and withdraws through tank line 311 the fluid 301 from tank 309. The column output line 313 may optionally include a fluid collector 304. Fluid collector 304 may be a device for measuring flow rate, such as gravimetric device. A first optional filter 308 may be positioned in tank line 311 between the tank 309 and pump 307. Furthermore, one or more of an optional second filter 302, optional flow rate gauge 306 and optional pressure gauge 305 may be positioned between the pump 307 and column 301. Optional three-way ball valves used to redirect the flow between reverse flow (to fluidize the bed) and normal operational flow are not depicted in FIG. 13.

About 653.25 g of agglomerated cerium dioxide corresponding to a bed volume of about 891 ml was rinsed several times with deionized water to substantially remove fine particles before being degassed in a vacuum flask. The agglomerated cerium dioxide had an average particle size from about 300 μm to about 425 μm. The cerium dioxide agglomerated with a PVDF binder. After being rinsed and degassed the agglomerated cerium dioxide was packed into column 301. The column 301 had an internal diameter of about 2 inches. The agglomerated cerium dioxide loaded column 301 was backwashed with deionized water to fluidize and repack the agglomerated cerium dioxide. The repacking of the agglomerated cerium dioxide by fluidization substantially homogenizes the agglomerated cerium dioxide bed and reduces, if not substantially eliminates, channeling of fluid through the repacked agglomerated cerium dioxide filter bed 303. Moreover, fluidizing and repacking of the agglomerated cerium dioxide filter bed 303 forms a level and/or smooth bed surface 315 for contacting fluid 310.

The repacked column was pressure tested with deionized water. Fluid flow rates and pressures (see FIG. 5) were determined gravimetrically, using collector 304, by measuring fluid mass exiting the output line 313 per unit time.

The flow rates tested were from about 223 mL/min to about 2,762 mL/min. The 2,762 mL/min flow rate corresponds to a rate of about 3.1 Vb/min. Pressure drops were measured about 3 to about 5 minutes after each flow rate change. A pressure drop of about 28 psi was observed at a flow rate of about 3 bed volumes per minute.

### Example 6

An agglomerated cerium dioxide packed column set-up 300 (as depicted in FIG. 4) was continuously challenged with an arsenic (III)-containing aqueous solution having about 500 parts per billion arsenic. Column 301 was about 36 inches long and had an internal diameter of about 2 inches. The column 301 was packed with about 223 grams of agglomerated cerium dioxide of Example 1. The agglomerated cerium dioxide filter bed 303 had a bed volume of about 171 mL. The agglomerated cerium dioxide was rinsed prior to packing the column 301. The packed column 301 was fluidized and repacked (as described above in Example 5) prior to being challenged with the arsenic (III)-containing aqueous solution. The repacked column was challenged with the arsenic (III)-containing solution at a flow rate of about 0.67 Vb/min, which corresponds to about 115 mL/min. The arsenic (III)-containing aqueous solution pH was adjusted to about pH 7.5 with HEPES prior to challenging the agglomerated cerium dioxide packed column. Fresh arsenic (III)-containing solution having a pH of about pH 7.5 was prepared daily.

Agglomerated cerium dioxide bed height, column pressure drop and flow rate were measured about every 60 seconds. Initial pressure drop at start-up flow rate of about 0.67 Vb/min was about 0.2 PSI. After about three weeks of continuous operation, the pressure drop increased to about 1.2 PSI. Most of the pressure drop was believed to be due to air bubbles trapped at the top of the column. The agglomerated cerium dioxide bed height remained substantially unchanged during the test period.

A slight coloration developed at the top of the agglomerated cerium dioxide bed, where the arsenic (III)-containing aqueous solution firsts encounters the agglomerated cerium dioxide. The coloration change observed is typically associated with arsenic (III)-loading of cerium dioxide. As the agglomerated cerium dioxide bed was further challenged with arsenic (III) the coloration progressed further down the agglomerated cerium dioxide bed.

Effluent samples were collected from output line 313 at two-hour intervals. The effluent samples were analyzed by inductively coupled plasma mass spectrometry (ICP MS) for arsenic and cerium. The ICP MS detection limit for arsenic is about 2 ppb and for cerium about 10 ppb. Cerium was not detected in the effluent during testing, therefore, it was concluded that the agglomerated cerium dioxide released insignificant amounts of cerium-containing fines during the test period. The pH valves of the arsenic (III)-containing solution contained within the tank 309 and output line 313 containing solution were determined about every 12 hours.

On about the twenty-second day of the arsenic (III) challenge, the column had treated more than about 3700 L of the 500 ppb arsenic (III)-containing aqueous solution. Through this test period the effluent remained below about 2 ppb arsenic and 10 ppb cerium. Furthermore, about the upper two thirds of the agglomerated cerium dioxide bed height had a slight coloration change indicative of arsenic (III)-loaded cerium dioxide.

The column effluent first contained about 10 ppb of arsenic on about the forty-seventh day of the arsenic (III) challenge, at this point about 7,645 L of 500 ppb arsenic (III)-containing aqueous solution had been treated by the 223 grams agglomerated cerium dioxide bed. This corresponds to a removal capacity of 17.1 mg of arsenic (III) per gram of the agglomerated cerium dioxide.

Table 2 provides various column configurations for removing contaminates, such as arsenic (III), under differing operating conditions. The column configurations were calculated using a 0.67 VB/min flow rate, an agglomerated cerium dioxide bed density of 1.30 g/L and a 10 ppb arsenic (III) breakthrough valve.

TABLE 2

| | Original | New Flow | Flow | Column | Number | TSM Media | Treated |
|---|---|---|---|---|---|---|---|
| | Flow rate | rate | Rate | Volume | of | Weight | Volume |
| System | (Vb/min) | (Vb/min) | (L/Min) | (L) | Columns | (kg) | (L)* |
| Example 3 | NA | 0.67 | 0.115 | 0.1714 | 1 | 0.223 | 7,627 |
| Calculated | 1.4 | 0.67 | 7.95 | 5.66 | 2.1 | 7.4 | 251,847 |
| Condition 1 | | | | | | | |
| Calculated | 0.84 | 0.67 | 94.6 | 113.27 | 1.3 | 147.4 | 5,040,052 |
| Condition 2 | | | | | | | |
| Calculated | 2.01 | 0.67 | 56.8 | 28.32 | 3.0 | 36.8 | 1,260,124 |
| Condition 3 | | | | | | | |
| Calculated | 0.67 | 0.67 | 189.3 | 283.17 | 1.0 | 368.4 | 12,599,909 |
| Condition 4 | | | | | | | |

### Example 7

Example 7 is an evaluation of various agglomerates prepared with cerium dioxide having an average particle size of in the micron range and of various agglomerations prepared with cerium dioxide having an average particle size in the nanometer range.

The micron range cerium dioxide had an average particle size of about 30 to about 50 microns. More specifically, the micron range cerium dioxide had an average particle size of about 31.17 μm, an average surface area of about 124.41 m²/g, an average pore volume of about 0.06 cm³/g and an average pore size of about 2.86 nm. Visually, the micron range cerium dioxide had a bright yellow color. Moreover, the micron range cerium dioxide was a Molycorp ceria produced on Oct. 16, 2010 according to standard Molycorp ceria production procedures. The pore volume, pore size, particle size, and loss on ignition values for the micron range cerium dioxide are given in Table 5. The pore volume and size values were determined by BJH absorption. The particle size ranges are defined in percentages of 5, 50 and 95% being less than the size given. For example, sample 1 of Table 3 shows that only 5% of the ceria powder has a size less than about 6.5 microns. The loss on ignition values were determined by calcining at 1000 degrees Celsius. The, respective, percent loss of water and carbonate are calculated from mass loss before and after calcining

TABLE 3

| | Surface | Pore | Pore | | | | Total | | |
|---|---|---|---|---|---|---|---|---|---|
| | Area | Volume† | Size† | Particle Size (μm) | | | LOI | % H₂O | % CO₃ |
| Sample | (m2/g) | (cm3/g) | (nm) | 5% | 50% | 95% | (%) | LOI* | LOI* |
| 1 | 113.87 | 0.057 | 4.83 | 6.5 | 28.98 | 64.64 | 5.33 | 2.82 | 2.45 |
| | 123.3 | 0.058 | 4.95 | — | — | — | — | — | — |
| 2 | 116.97 | 0.056 | 5.08 | 5.69 | 26.84 | 63.17 | 5.20 | 2.68 | 2.45 |
| | 114.6 | 0.055 | 5.03 | — | — | — | — | — | — |
| 3 | 126.08 | 0.065 | 4.87 | 6.38 | 29.03 | 64.85 | 5.63 | 2.80 | 2.72 |
| | 120 | 0.056 | 4.70 | — | — | — | — | — | — |

†average value as determined by BJH Absorption
*estimated value

The nanometer cerium dioxide had an average particle size of no more than about 25 nm. More specifically, the nanometer cerium dioxide had an average surface area of above 35.7 m²/g, an average pore volume of about 0.18 cm³/g and an average pore size of about 17.80 nm. Visually, the nanometer cerium dioxide had a pale yellow color. The nanometer cerium dioxide was purchased from Sigma Aldrich, Lot MKBD9646V. However, it should be noted that the larger pore volume and pore size of the nanometer cerium dioxide is questionable because the nanometer particles may be too small to give accurate pore volume and pore size determinations according to the measurement procedures utilized.

Extrusion Process

Tables 3 and 4 describe amounts of Kynar™ Aquatech 10206 (47 wt % solids) and Picassian™ XL-702 (40 wt % solids) added to distilled water in a 250 mL cup to form a polymeric binder solution. Kynar™ Aquatech 10206 is an aqueous solution of a PVDF-acrylic polymeric composition sold by Arkema. Picassian™ XL-702 is an aqueous solution of a poly-carbodiimide acrylic cross-linker sold by Picassian™. The polymeric binder composition comprises the PVDF-acrylic polymer and the poly-carbodiimide acrylic cross-linker compositions. Half of the mass of ceria particles indicated in Tables 4 and 5 was added with hand mixing to the polymeric binder solution to form a first mixture. The first mixture was mixed by hand until substantially all of the ceria particles were wetted with the polymeric binder solution. After substantially all of the ceria particles were wetted, the first mixture was placed in a Keyence™ HM501 hybrid mixer and the first mixture was mixed for about a 30 second period. After the 30-second mixing period in the HM501 mixer, the first mixture was removed from the HM501 hybrid mixer and returned to the 250 mL cup. The second half of the ceria particles was added the first mixture to form a second mixture. The second mixture was hand mixed to substantially wet all of the ceria particles in the second mixture with the polymeric binder solution. After substantially wetting all of the ceria in the second mixture, the second mixture was placed in the Keyence™ HM501 hybrid mixer and mixed for about a 30-second period to form a paste.

TABLE 4

BM66-

| | 57-1 | 57-2 | 57-3 |
|---|---|---|---|
| Xorbx ™ Ceria | 65.6 g | 64.18 g | 62.74 g |
| Aquatic 10206 [symbol] | 1.82 g | 2.26 g | 2.72 g |
| XL-702 [symbol] | 0.54 g | 0.68 g | 0.82 g |
| Water (distilled) | 18 ml | 18 ml | 17 ml |

*Aquatic is 47% solids, XL-702 is 40% solids [symbol]
mass is mass of substance on dry basis

TABLE 5

BM63-

| | 96-1 | 96-2 | 96-3 |
|---|---|---|---|
| Nano-crystalline ceria | 65.6 g | 64.18 g | 62.74 g |
| Aquatic 10206 [symbol] | 1.82 g | 2.26 g | 2.72 g |
| XL-702 [symbol] | 0.54 g | 0.68 g | 0.82 g |
| Water (distilled) | 18 ml | 18 ml | 17 ml |

*Aquatic is 47% solids, XL-702 is 40% solids [symbol]
mass is mass of substance on dry basis

The paste was charged to a Fuji-Paudal KAR-75 granulator equipped with an extrusion screen having 381 μm diameter orifices. The paste was extruded, under pressure to form an extrudate. The extrudate was in the form of a cylindrical-shaped strand. The extrudate was extruded into a hot circulating airflow having a temperature from about 60 to 70 degrees Celsius. A mandrel assisted the extrusion of the paste through the extrusion screen.

The extrudate was collected and dried for about sixteen hours in an oven at a temperature of about 60 degrees Fahrenheit to form a dried extrudate. The dried extrudate was heated to and maintained for about 2 hours at a temperature of about 120 degrees Celsius to substantially cure the polymeric binder composition and form cured extrudate strands. The cured extrudate strands comprising the micron range cerium dioxide visually had a yellow-brown color, while the cured extrudate comprising the nanometer cerium dioxide visually had a more tan/brown in color.

The cured extrudate strands were charged to a model RBF10 Vorti-Siv shaker equipped with a 10-inch diameter screen having 600 μm square pattern orifices (which corresponds to about a 30-mesh size screen) and a rotating nylon brush. The cured extrudate strands were broken by the shaker. The broken strands passing through the 600 μm square pattern orifices formed a first broken-batch of strands. The first broken batch of strands was charged to the Vorti-Siv shaker, equipped with a 10-inch diameter screen having 425 μm square pattern orifices (which corresponds to about a 40-mesh size screen). The strands passing through the 425 μm square pattern orifices formed a second-broken batch of strands.

The second-broken batch of strands was manually sieved in a stack of Tyler mesh screens arranged in a top to down order of 425, 300, 180 and 106 μm (with the 425 μm screen at the top and the 106 μm screen at the bottom). The second-broken batch of strands was charged to the 425 μm screen. After manually sieving the second-broken batch of strands, broken strands retained by each of the 425, 300, 180 and 106 μm Tyler mesh screens were collected and weighted separately. Table 6 summarizes the collected data. At least most of the mass of the second-broken batch of strands has a size from about 300 to about 425 μm.

TABLE 6

| | | | % Yield of Each Fraction | | | |
|---|---|---|---|---|---|---|
| Agglomerate Initial Sieve Results | | | 300-425 | 180-300 | 106-180 | <106 |
| Sample ID | Media | Process | μm | μm | μm | μm |
| BM63-96-1 | Nano | Extrusion | 76.75 | 18.19 | 2.38 | 2.68 |
| BM66-57-1 | Xsorbx ™ | Extrusion | 87.94 | 4.75 | 1.01 | 6.3 |
| BM63-96-2 | Nano | Extrusion | 81.31 | 12.73 | 2.73 | 3.23 |
| BM66-57-2 | Xsorbx ™ | Extrusion | 88.67 | 4.22 | 1.08 | 6.03 |
| BM63-96-3 | Nano | Extrusion | 86.73 | 9.88 | 1.41 | 1.98 |
| BM66-57-3 | Xsorbx ™ | Extrusion | 88.13 | 3.74 | 1.51 | 6.62 |

A packing density determination was made for each sample the second-broken batch of strands having a size from about 300 to about 425 μm. A given mass of each formulation having a size from about 300 to about 425 μm was charged to a graduate cylinder. After charging the cylinder, the cylinder was gently tapped until particle settling appeared to stop, at which point the volume of settled particles was recorded. The packing density is the ratio of mass of particles charged to the graduate cycliner divided by settled particle volume. Table 7 summarizes the packing density data for various agglomerate cerium dioxide formulations.

TABLE 7
Tap Density 300-425 μm Fraction

| Sample ID | Media | Process | Tap Density g/cc |
|---|---|---|---|
| BM63-96-1 | Nano | Extrusion | 1.471 |
| BM66-57-1 | Xsorbx | Extrusion | 1.317 |
| BM63-96-2 | Nano | Extrusion | 1.517 |
| BM66-57-2 | Xsorbx | Extrusion | 1.252 |
| BM63-96-3 | Nano | Extrusion | 1.471 |
| BM66-57-3 | Xsorbx | Extrusion | 1.252 |

Comparative strengths of the formulations in Tables 6 and 7 were determined by measuring fine particle content.

TABLE 8
Agglomerate Granule Strength 300-425 μm Fraction

| | | | Loss | Loss | Loss |
|---|---|---|---|---|---|
| | | | mg/g, | mg/g, | mg/g, |
| Sample ID | Media | Process | Method B | Method C | Method A |
| BM63-96-1 | Nano | Extrusion | 9.9 | 16.6 | 47.7 |
| BM66-57-1 | Xsorbx ™ | Extrusion | 29.8 | 31.0 | |
| BM63-96-2 | Nano | Extrusion | 8.8 | 14.9 | 23.9 |
| BM66-57-2 | Xsorbx ™ | Extrusion | 17.9 | 29.5 | |
| BM63-96-3 | Nano | Extrusion | 9.1 | 13.7 | 22.1 |
| BM66-57-3 | Xsorbx ™ | Extrusion | 125.3 | 29.1 | |

Capacity Studies

The capacities for arsenic removal for a micron range cerium dioxide agglomerate (corresponding to Sample BM63-96-1 of Table 8) and nanometer range cerium dioxide agglomerate (corresponding to Sample BM66-57-1 of Table 8) were determined. The micron range cerium dioxide agglomerate contained 8 volume % of carbodiimide cross-linked polyvinylidene fluoride-acrylic binder. The nanometer range cerium dioxide agglomerate contained 10 volume % of carbodiimide cross-linked polyvinylidene fluoride-acrylic binder. The second-broken batch of strands having a size from about 300 to about 425 μm for each of the micron range cerium dioxide and nanometer range cerium dioxide agglomerates (hereinafter within this capacity studies section is referred to as “media”) were used in this capacity study. Table 9 summarizes the characteristics of the media.

TABLE 9

| | Particle | Surface | Pore | Pore | Tap | |
|---|---|---|---|---|---|---|
| | Size | Area | Volume | Size | Density | wt % |
| Media | (μm) | (m²/g) | (cm³/g) | (nm) | (g/mL) | Polymer |
| Molycorp HSA | 31.17 | 124.4 | 0.06 | 2.86 | 1.16 | — |
| Ceria Powder | | | | | | |
| Agglomerated | 300-425 | 100.5 | 0.057 | 5.39 | 1.33 | 2.03 |
| Molycorp HSA | | | | | | |
| Ceria Powder | | | | | | |
| Nano- | <0.025 | 35.8 | 0.18 | 17.80 | 0.38 | — |
| Crystalline | | | | | | |
| Ceria Powder | | | | | | |
| Agglomerated | 300-425 | 32.2 | 0.191 | 18.17 | 1.67 | 2.03 |
| Nano- | | | | | | |
| Crystalline | | | | | | |
| Ceria Powder | | | | | | |

For each of the micron range cerium dioxide and the nanometer range cerium dioxide agglomerates, about 45 mL of the media was charged to a graduated cylinder. After charging the graduated cylinder, the media was packed by gently tapping the cylinder. The volume of the packed media was recorded. The media was transferred to a glass vacuum flask and 100 mL deionized water was charged to the vacuum flask to form an aqueous slurry of the media. The vacuum flask was sealed, the pressure within the flask was reduced using a vacuum pump, and the vacuum flask was swirled by hand to substantially submerge and wet the media. The media was soaked in the deionized water for about 30 minutes. After the 30-minute soaking period, the deionized water was decanted. The soaking and decanting of the media was repeated until the decanted water was substantially free of fine particles to form a fine-free media. Typically the decanted water was substantially free of fine particles after about four soak/decant cycles.

The fine-free media was mixed with deionized water to form a fine-free slurry. The fine-free media slurry was charged to a one-inch internal diameter column configured according to the column set-up 300, described above. The fine-free media was packed in the column 301 in the form of an aqueous slurry prepared with deionized water. After the 5-minute settling period, deionized water was flowed through the column to further settling the media. After which, the deionized water in column 301 above the media bed 303, within tank line 311, and, in in-put line 312 was removed and replaced with an NSF-53 solution, see Table 10 for composition of the NSF-53 solution. The pH of the NSF-53 solution was adjusted to pH 7.5 with 1 N NaOH and/or 0.3 N HCl.

TABLE 10

| Regent | Concentration (mg/L) |
|---|---|
| Sodium Silicate | 93.00 |
| Sodium Bicarbonate | 250.00 |
| Magnesium Sulfate | 128.00 |
| Sodium Nitrate | 12.00 |
| Sodium Fluoride | 2.20 |
| Sodium Phosphate | 0.18 |
| Calcium Chloride | 111.00 |
| Arsenate (As V) | 0.30 |

About every hour of operation, the collector 304 collected al 0 mL sample of the effluent. The collected effluent sample was analyzed for arsenic using inductively coupled plasma-mass spectrometry. The column set-up was operated continuously until 50 μg/L or more of arsenic (V) was detected in the effluent.

FIG. 7 and Table 11 summarize the capacity study results. The micron range cerium dioxide agglomerated media reached the 50 μg/L arsenic breakthrough value after treating about 307 L of the arsenic (V)-containing NSF-53 solution, while the nanometer range cerium dioxide Agglomerated media treated about 561 L before reaching the 50 μg/L arsenic breakthrough value. This correlates to arsenic capacity values of 1.53 mg As/g media for the micron range ceria agglomerate and 2.19 mg As/g media for the nanometer range ceria agglomerate. Moreover, the capacities for micron range and nanometer range ceria to remove arsenic are, respectively, 1.57 and 2.23 mg/ceria.

TABLE 11

| | | | | Capacity |
|---|---|---|---|---|
| | Volume | Mass | Capacity | by Mass |
| | 50 μg/L | Media | by Mass | Ceria |
| Media | Breakthrough | Used | Media | Only |
| Molycorp HSA | 307 L | 57.38 g | 1.53 mg | 1.57 mg |
| Agglomerated Ceria | | | As/g Media | As/g CeO₂ |
| Nano-Crystalline | 561 L | 75.09 g | 2.19 mg | 2.23 mg |
| Agglomerated Ceria | | | As/g Media | As/g CeO₂ |

### Example 8

Rare earth-containing agglomerates were made by a process in which the binder emulsion and ceria were mixed to form a paste consistency by a hybrid shear mixer Keyence HM-501. The binder was fed into an extruder and extruded into strands having a length of more than 2 mm. The extruder was a Fuji Paudal basket, twin dome, or radial extruder. The extruded strands were dried and, depending on the binder, optionally cured. The dried and/or cured strands were vibrated and broken into particles approaching a 1:1 aspect ratio (relative to strand diameter as determined by extrusion screen orifice size). The strands were broken by vibration or by addition of media such as nylon brushes or ceramic balls to vibration process. The particles were classified and evaluated, see Table 12 for a summary of the results.

TABLE 12

| Binder | | | Approx. | | |
|---|---|---|---|---|---|
| Reference | | | Vol. % | Approx. | |
| Number | Type | Grade | Range | Size, μm | Result |
| BM53-133-1 | XL | Aquatec | 15 | 600-825 | Excellent str; |
| BM53-161-1 | fluoropolymer | 30%/XL-702 | | | low capacity |
| BM53-174-1-3 | XL | Aquatec | 10-15 | 600-825 | Excellent |
| | fluoropolymer | 30%/XL-702 | | | strength |
| BM53-172-1 | Fluoropolymer | Aquatec 30% | 15 | 600-850 | Good |
| | | acrylic | | | strength |
| BM53-172-2 | Fluoropolymer | Aquatec 50% | 15 | 600-850 | Fair strength |
| | | acrylic | | | |
| BM53-172-3 | Polyurethane | Picassian PU | 15 | 600-850 | Fair str; poor |
| | | 429 | | | wetting |
| BM53-175-1 | Polyvinylalcohol* | Mowiol 56-98 | 15 | 600-850 | Poor str |
| BM53-175-2 | XL Ethylene | Dur-O-Set | 15 | 600-850 | Poor str |
| | Vinyl Acetate | 351/XL702 | | | |
| BM53-185-1 | XL | Aquatec | 10 | 600-850 | Good |
| | fluoropolymer | 30%/XL-702 | | | capacity |
| BM53-186-1 | Polyvinylalcohol* | Mowiol 56-98 | 12 | 600-850 | Poor |
| | | | | | capacity |
| | | | | | (swelling?) |
| BM63-08 | XL | Aquatec | 10 | 425-600 | Good |
| | fluoropolymer | 30%/XL-702 | | | capacity |
| BM63-16 | XL | Aquatec | 10 | 300-425 | V. good |
| | fluoropolymer | 30%/XL-702 | | | capacity |
| BM63-54-1 | Ethylene Vinyl | Dur-O-Set | 10 | 300-425 | V. good |
| | Acetate | E200 | | | capacity |
| BM66-25-1 | Acrylic | HYCAR | 10 | 300-425 | V. good |
| | | 26288 | | | capacity |
| BM66-39-1 | Acrylic | HYCAR | 10 | 425-600 | Fair capacity |
| | | 26288 | | | |
| BM66-25-2 | Fluoropolymer | Aquatec | 10 | 300-425 | — |
| | | 10206 Not XL | | | |
| BM66-25-3 | Vinyl Cl | VYCAR | 10 | 300-425 | — |
| | copolymer | 660X14 | | | |
| BM66-various | Polyvinylidene | Serfene 400, | 10-18 | 425-600 | Poor strength |
| | chloride | Serfene 2022 | | | |

*case of binder dissolved in carrier fluid; rest are all emulsion systems
XL = crosslinked
Aquatec 30% is Aquatec 10206 ™ or comerically Aquatec ARC ™
Aquatec 50% acrylic is Aquatec 102044 ™

### Example 9

Example 9 describes forming paper pulp agglomerations of cerium oxide particles. 0.2-0.5 g of paper pulp fibers and 2 g of cerium oxide powder (30-50 micron average particle size) were charged to a 15 mL centrifuge tube. 7 mL of water was added to the mixture and the tube was shaken aggressively for 10-30 seconds. The tip was cut off the tube producing an orifice having approximately 2 mm diameter, a bed of the paper pulp fibers formed as the water was drained. Little, if any, of the cerium oxide particles were loss as the water drained through the paper pulp bed. It is envisioned from this experiment that a larger bed of powder mixed with paper pulp could be supported on a relatively course screen-like surface. Data were collected on the relationship between paper pulp content (mass) and the pressure drop experienced across a column containing 2 g of powdered ceria when water was pumped through the column at different flow rates. It was found that as the paper pulp content increased, the pressure drop at each flow rate tested decreased. However, both the associated bed expansion due to pulp content and the subsequent bed compaction (due to elevated pressures being applied) were undesirable byproducts of pulp addition. The presence of paper pulp did not affect the removal of a target material by cerium oxide, that is, the paper pulp did not affect the arsenic removal capacity. Similar ratios of cerium oxide to paper pulp yielded batches of batter-like material that could be formed into disks and dried, the dried disks could be handled with minimal ceria dusting.

### Example 10

Example 10 describes the forming cerium oxide fibers from a cotton fiber template. From a 100% cotton terry cloth a 2-by-2 inch square sample was therefrom. After soaking the sample in deionized water to “swell” the cotton fibers, the sample was transferred to a 40 wt % Ce(NO3)3 solution. The sample was soaked in the Ce(NO3)3 solution overnight (about 19 hours), after which the sample was removed from the solution and transferred to a furnace. The furnace temperature was ramped over about a fifteen minutes from about 70° C. to about 100° C., after which the furnace temperature was increased 50° C. about every hour to a final temperature of about 400° C. Care needed to be taken to not ignite the cotton fiber template. The furnace temperature was maintained at about 400° C. for 30 minutes, followed by a 3 hour cool down. The cotton fiber template removed from the furnace was brittle and visibly fibrous and had a specific surface area of no more than about 5 m2/g. The robustness, such as surface area, did not improve when the cotton fiber template was calcined at a temperature of about 700° C.

A number of variations and modifications of the disclosure can be used. One of more embodiments of the disclosure can used separately and in combination. That is, any embodiment alone can be used and all combinations and permutations thereof can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the various embodiments, configurations, or aspects after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that any claim and/or combination of claims require more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment.

Moreover, though the description of the disclosure has included descriptions of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A filter block, comprising:
agglomerated cerium oxide particles, wherein the cerium oxide particles are agglomerated together with a polymeric binder; and
activated carbon particles,
wherein the agglomerated cerium oxide particles and activated carbon particles are substantially homogeneously intermixed, wherein the agglomerated cerium oxide particles are cohesively bonded to the activated carbon particles by a thermoplastic binder, wherein the polymeric and thermoplastic binders differ.

2. (canceled)

3. The filter block of claim 2, wherein at least most of the agglomerated cerium oxide particles are in contact with the polymeric binder.

4. (canceled)

5. The filter block of claim 1, wherein the agglomerated cerium oxide particles have a surface area of more than about 5 m²/g.

6. The filter block of claim 1, where the agglomerated cerium oxide particles have an average and/or mean pore volume of more than about 0.02 cm³/g.

7. The filter block of claim 1, wherein the agglomerated cerium oxide particles have an average and/or mean particle size from about 1 μm to about 1,000 μm.

8. The filter block of claim 1, wherein the agglomerated cerium oxide particles have an average and/or mean particle size from about 1 nm to about 100 nm.

9. The filter block of claim 1, wherein the agglomerated cerium oxide particles comprise one of cerium (IV) oxide, cerium (III) oxide, or a mixture thereof.

10. The filter block of claim 9, wherein the cerium oxide comprising the agglomerated cerium particles are derived from cerium carbonate.

11. The filter block of claim 1, wherein the filter block has a shape generally resembling one of a sheet, a film, solid cylinder, or tubular cylinder.

12. The filter block of claim 1, wherein the activated carbon particles have one of an average or mean particle size from about 40 μm to about 300 μm.

13-35. (canceled)

36. The filter block of claim 1, further comprising
one or more of arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, or a chemical contaminant one or both of absorbed and adsorbed by at least some of the agglomerated cerium oxide particles.

37. The filter block of claim 36, further comprising:
one or more of arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, or a chemical contaminant one or both of absorbed and adsorbed by the activated carbon particles.

38. The filter block of claim 37, wherein the agglomerated cerium oxide particles one or both of absorbed and adsorbed a first contaminant, wherein the activated carbon particles one or both of absorbed and adsorbed a second contaminant and wherein one of the following is true:
i) the first and second contaminants substantially differ; and
ii) the first and second contaminants are substantially the same.

39. The filter block of claim 1, wherein the filter block comprises about 20 to about 90 wt % activated carbon particles, from about 80 to about 10 wt % cerium oxide and from about 5 to about 50 wt % thermoplastic binder.

40. The filter block of claim 1, wherein the thermoplastic binder is substantially interspersed with the activated carbon particles and the agglomerated cerium oxide particles and binds the activated carbon and agglomerated cerium oxide particles together.

41. The filter block of claim 1, wherein the activated carbon particle mass to cerium oxide particle mass ratio is one of from about 0.1:10 to about 10:0.1.

42. The filter block of claim 1, wherein the agglomerated cerium oxide particles further include one or more of particle surface modification additives, coupling agents, plasticizers, fillers, expanding agents, fibers, antistatic agents, initiators, suspending agents, photosensitizers, lubricants, wetting agents, surfactants, pigments, dyes, UV stabilizers, and suspending agents.

43. The filter block of claim 1, wherein the filter block further includes one or more flow aids.

44. The filter block of claim 43, wherein the one or more flow aids are selected from the group consisting of ferric sulfate, ferric chloride, ferrous sulfate, aluminum sulfate, sodium aluminate, polyaluminum chloride, aluminum trichloride, silicas, diatomaceous earth, organic flocculents known in the art such as polyacrylamides (cationic, nonionic, and anionic), EPI-DMA's (epichlorohydrin-dimethylamines), DADMAC's (polydiallydimethyl-ammonium chlorides), dicyandiamide/formaldehyde polymers, dicyandiamide/amine polymers, and natural guar.
